(19) United States
(12) Patent Application Publication
(10) Pub. No.: US 2007/0295339 A1
(43) Pub. Date: Dec. 27, 2007

(54) Loading/unloading unit and a transfer apparatus

(76) Inventors: Osamu Mizuno, Osaka (JP); Tohru Nakamura, Osaka (JP); Soichiro Fujioka, Osaka (JP); Hideo Kawakami, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/819,442

(22) Filed: Jun. 27, 2007

(30) Foreign Application Priority Data
Jun. 27, 2006 (JP) 2006-176826

(51) Int. Cl. A61G 13/12

(52) U.S. Cl. 128/845; 5/83.1

(57) ABSTRACT

A loading/unloading unit is formed with an oblique surface and an upper surface having contact areas to come into contact with a cared person, and the oblique surface and the upper surface of the loading/unloading unit are vibrated in a load direction and an unload direction upon loading the cared person on the loading/unloading unit or unloading the cared person from the loading/unloading unit. Therefore, a transfer apparatus can safely transfer the cared person while preventing an occurrence of the entanglement of the hair and the like of the cared person.

### BACKGROUND OF THE INVENTION

1. Field of the Invention

The present invention relates to a loading/unloading unit and a transfer apparatus for supporting the transfer of a person to be cared from a bed or the like to another thing.

2. Description of the Background Art

There has been an increase in the number of people to be cared with aging population combined with declining birthrate in recent years, and a decrease in the number of carers in the near future is expected. Out of caring works, a transfer work of transferring a person to be cared (cared person) from a bed or the like to another bed or a wheelchair is a large physical burden on a carer and, with a decline in the number of carers, such a burden will further increase.

In view of such a situation, there have been conventionally proposed several transfer apparatuses for supporting the transfer work. FIGS. 34A to 34D show an example of a loading/unloading unit using a belt mechanism, and a transferring state from a left bed to a right bed is successively shown in FIGS. 34A to 34D. This is a construction used to insert the loading/unloading unit under a cared person without any large resistance.

The loading/unloading unit shown in FIGS. 34A to 34D includes a belt 201 at an upper part and a belt 202 at a lower part. First, when the belts 201, 202 are respectively rotated in directions of arrows AA1, AA2 as shown in FIGS. 34A and 34B, the entire loading/unloading unit is moved to left by the belt 202. At this time, since the rotating direction of belt 201 is opposite to that of the belt 202, point P1 on the belt 201 does not move relative to a cared person CP or the beds. Accordingly, the loading/unloading unit can slip under the cared person CP as it is, thereby reaching the state of FIG. 34C. Thereafter, the belt 201 is stopped as shown in FIG. 34D and only the belt 202 is rotated in a reverse direction. Then, the cared person CP can be transferred to the right bed (see, for example, Japanese Unexamined Patent Publication No. S62-253057).

An example shown in FIG. 35 is a loading/unloading unit 210 using a multitude of small-size actuators 211. In the loading/unloading unit 210 shown in FIG. 35, the small-size actuators 211 can successively transfer an object in contact with the outer surfaces thereof as shown in FIGS. 36A to 36D, and can transfer a cared person CP from a movable bed 211 to a bed 212 as shown in FIG. 37 (see, for example, Japanese Unexamined Patent Publication No. 2005-304735).

Other examples of the transfer apparatus include an armed lifting apparatus with which a carer scoops a cared person up by operating supporting parts 304 to transfer the cared person (see, for example, Japanese Unexamined Patent Publication No. H10-295744).

However, the conventional loading/unloading units had the following problems because they utilize largely movable mechanisms. For example, since the loading/unloading unit shown in FIGS. 34A to 34D includes the belt mechanism, there were cases where the hair, clothes, bedclothes or the like of the cared person was caught by relatively moving mechanism portions (e.g. between the belt and a drive shaft). Further, the loading/unloading unit shown in FIG. 35 had problems that the hair and the like were entangled in many projections and recesses and cleaning was difficult due to the uneven surface. Further, the conventional transfer apparatuses took no consideration for a relative inclination and the like of a cared person and there was a possibility of an unstable supported state depending on a movement and the like of the cared person.

### SUMMARY OF THE INVENTION

An object of the present invention is to provide a loading/unloading unit and a transfer apparatus capable of safely transferring a cared person by preventing an occurrence of the entanglement of the hair and the like of a cared person.

One aspect of the present invention is directed to a loading/unloading unit, comprising a base formed with a contact portion having a contact area to be brought into contact with a cared person, wherein a friction state between the contact area and the cared person is variable.

Since the friction state between the contact area and the cared person is variable by the above construction, the cared person can be loaded on the base or unloaded from the base without providing any large mechanical displacing portion. Therefore, the cared person can be safely transferred by preventing an occurrence of the entanglement of the hair and the like of the cared person.

### BRIEF DESCRIPTION OF THE DRAWINGS

FIGS. 1A and 1B are schematic diagrams showing the construction of a transfer apparatus according to a first embodiment of the invention,

FIGS. 2A to 2F are schematic diagrams showing an operation of the transfer apparatus shown in FIGS. 1A and 1B,

FIG. 3 is a graph showing a change of friction coefficient in relation to speed,

FIG. 4 is a schematic diagram showing another operation example of the transfer apparatus shown in FIGS. 1A and 1B,

FIG. 5 is a schematic diagram showing a construction in which a friction member is added to the transfer apparatus shown in FIGS. 1A and 1B,

FIGS. 6A and 6B are schematic diagrams showing the construction of a transfer apparatus according to a second embodiment of the invention,

FIGS. 7A to 7C are schematic diagrams showing a transfer operation onto a loading/unloading unit shown in FIGS. 6A and 6B,

FIGS. 8A to 8E are schematic diagrams showing another operation example of the transfer apparatus shown in FIGS. 6A and 6B,

FIG. 9 is a schematic diagram showing a construction in which a friction member is added to the transfer apparatus shown in FIGS. 6A and 6B,

FIGS. 10A and 10B are schematic diagrams showing the construction of a transfer apparatus according to a third embodiment of the invention,

FIGS. 11A to 11E are schematic diagrams showing a transfer operation onto a loading/unloading unit shown in FIGS. 10A and 10B,

FIG. 12 is a schematic diagram showing another operation example of the transfer apparatus shown in FIGS. 10A and 10B,

FIGS. 13A and 13B are schematic diagrams showing the construction of a transfer apparatus according to a fourth embodiment of the invention,

FIGS. 14A and 14B are schematic diagrams showing the construction of an elastic fiber board shown in FIGS. 13A and 13B,

FIGS. 15A to 15C are schematic diagrams showing a transferring state of an object by the elastic fiber board shown in FIGS. 14A and 14B,

FIG. 16 is a perspective view showing a state where the elastic fiber boards shown in FIGS. 13A and 13B are projecting for the transfer operation,

FIG. 17 is a schematic diagram showing another operation example of the transfer apparatus shown in FIGS. 13A and 13B,

FIGS. 18A to 18C are schematic diagrams showing a transferring state of an object by the operation example shown in FIG. 17,

FIG. 19 is a schematic diagram showing a construction in which elastic fiber boards are further added to the transfer apparatus shown in FIGS. 13A and 13B,

FIG. 20 is a schematic diagram showing the construction of serrated plates usable in the transfer apparatus shown in FIGS. 13A and 13B,

FIG. 21 is a perspective view showing another operation example of the elastic fiber boards of the transfer apparatus shown in FIGS. 13A and 13B,

FIGS. 22A and 22B are schematic diagrams showing the construction of a transfer apparatus according to a fifth embodiment of the invention,

FIGS. 23A to 23C are schematic diagrams showing an occurrence of the inclination of a cared person on the transfer apparatus shown in FIGS. 22A and 22B,

FIG. 24 is a schematic diagram showing a positional relationship between distance sensors and markers of the transfer apparatus shown in FIGS. 22A and 22B,

FIG. 25 is a block diagram showing the electric construction of the transfer apparatus shown in FIGS. 22A and 22B,

FIG. 26 is a schematic plan view showing the construction of a transfer apparatus according to a sixth embodiment of the invention,

FIGS. 27A and 27B are schematic diagrams showing states where rollers shown in FIG. 26 at the time of low friction state and high friction state, respectively,

FIGS. 28A and 28B are schematic diagrams showing states of other rollers usable in a loading/unloading unit shown in FIG. 26 at the time of low friction and high friction, respectively,

FIGS. 29A and 29B are schematic diagrams showing states of other rollers usable in the loading/unloading unit shown in FIG. 26 at the time of low friction and high friction, respectively,

FIG. 30 is a schematic diagram showing a state of other rollers usable in the loading/unloading unit shown in FIG. 26 at the time of low friction and high friction,

FIG. 31 is a schematic diagram showing a state of other rollers usable in the loading/unloading unit shown in FIG. 26 at the time of low friction and high friction,

FIG. 32 is a schematic plan view showing the construction of a transfer apparatus according to a seventh embodiment of the invention,

FIG. 33 is a schematic side view showing the construction of a transfer apparatus according to an eighth embodiment of the invention,

FIGS. 34A to 34D are schematic diagrams showing the operation of a conventional loading/unloading unit,

FIG. 35 is a perspective view showing the construction of a conventional loading/unloading unit using a multitude of small-size actuators,

FIGS. 36A to 36D are schematic diagrams showing the operation of the small-size actuators shown in FIG. 35,

FIG. 37 is a perspective view showing the operation of the loading/unloading unit shown in FIG. 35, and

FIG. 38 is a perspective view showing another conventional transfer apparatus.

### DESCRIPTION OF PREFERRED EMBODIMENTS

Hereinafter, embodiments of the present invention are described with reference to the accompanying drawings.

### First Embodiment

A transfer apparatus according to a first embodiment of the present invention is designed to reduce friction between loading/unloading units and a cared person by vibrating contact areas of contact portions of the loading/unloading units. This transfer apparatus is provided with at least two loading/unloading units.

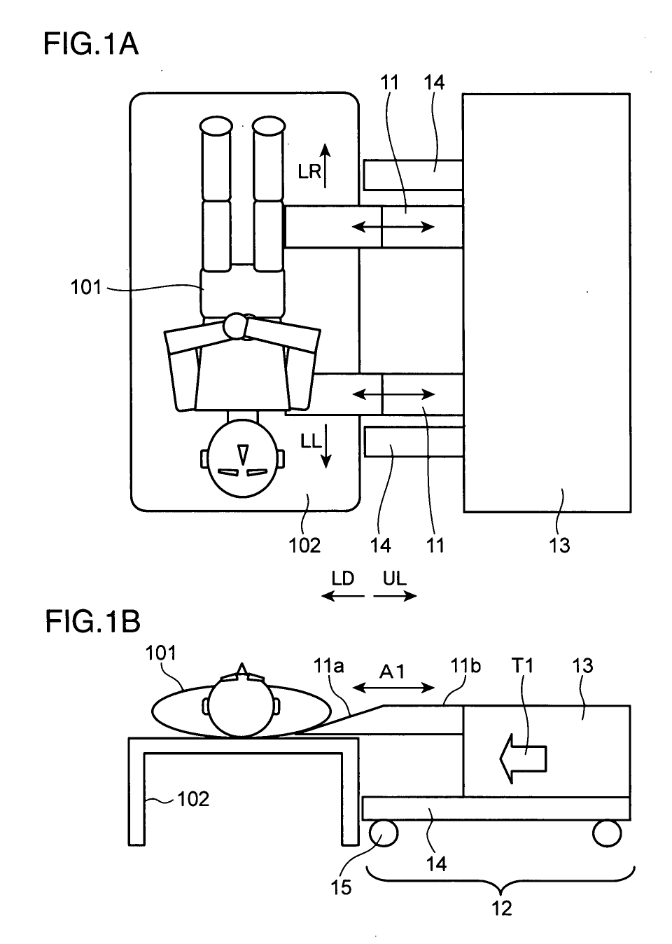

The construction of the transfer apparatus and that of the loading/unloading units used in the transfer apparatus of this embodiment are described below with reference to the drawings. FIGS. 1A and 1B are schematic diagrams showing the construction of the transfer apparatus according to the first embodiment of the present invention, wherein FIG. 1A is a plan view and FIG. 1B is a side view.

As shown in FIGS. 1A and 1B, a transfer apparatus 12 is provided with two loading/unloading units 11, and a transfer bed unit 13 arranged adjacent to the loading/unloading units 11. Outrigger-like leg portions 14 and a plurality of wheels 15 for enabling the transfer apparatus 12 to freely move on a horizontal plane are provided at the bottom part of the transfer apparatus 12 to stabilize the entire apparatus. Each loading/unloading unit 11 has a flat trapezoidal side view having a pointed leading end and vibrates in directions of both arrows A1 in FIG. 1B. At this time, a cared person 101 is lying down on his back on a bed 102. It should be noted that oblique surfaces 11a and upper surfaces 11b of the loading/unloading units 11 correspond to a contact portion having a contact area, and the loading/unloading units 11 correspond to a base.

A driving mechanism, an electromechanical conversion system, a driving circuit and the like for vibrating the loading/unloading units 11 are built in a lower part of the transfer bed unit 13. For example, a piezoelectric element, a mechanism for rotating an eccentric mass or the like may be used as a mechanism for generating vibration.

The loading/unloading units 11 vibrate in the directions of arrows A1 in FIG. 1B upon moving the cared person 101 on the oblique surfaces 11a and the upper surfaces 11b. If an inserting direction of the loading/unloading units 11 for the transfer of the cared person 101 to the loading/unloading units 11 is a load direction and an opposite direction thereof is an unload direction, a direction of arrow LD is the load direction and a direction of arrow UL is the unload direction in the example shown in FIGS. 1A and 1B. The vibration directions A1 of the loading/unloading units 11 coincide with the load and unload directions LD, UL.

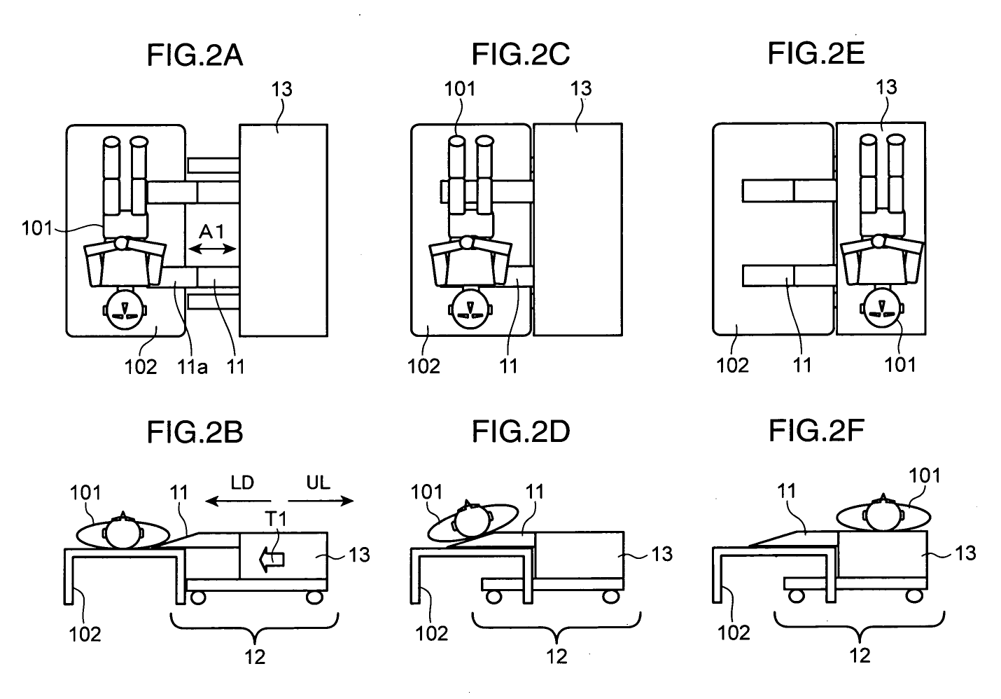

Next, the operation of the transfer apparatus 12 constructed as above is described. FIGS. 2A to 2F are schematic diagrams showing the operation of the transfer apparatus 12 shown in FIGS. 1A and 1B, wherein FIG. 2A is a plan view showing an initial state, FIG. 2B is a side view showing the state of FIG. 2A, and FIGS. 2C to 2F have similar correspondences.

First, the loading/unloading units 11 are inserted under the cared person 101 in the state shown in FIGS. 2A and 2B. At this time, the entire transfer apparatus 12 is moved in a direction of arrow T1 while the loading/unloading units 11 are vibrated in the both directions of arrows A1. Then, the oblique surfaces 11a as contact areas of the loading/unloading units 11 come into contact with the cared person 101. As the entire transfer apparatus 12 further advances, resistance is generated due to a frictional force created between the cared person 101 and the loading/unloading units 11.

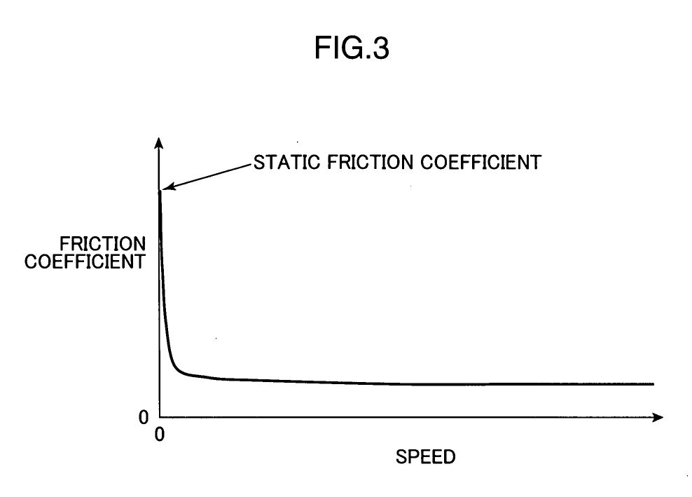

Amonton-Coulomb's law substantially holds for a frictional force and a normal force between two interfaces, where there is no large affinity and no liquid is present, in normal atmosphere, and a quotient of this frictional force divided by the normal force is a friction coefficient. This friction coefficient has speed dependency, an example of which is shown in FIG. 3.

Generally, the friction coefficient is as shown in FIG. 3 and a dynamic friction coefficient is smaller than a static friction coefficient. Since the loading/unloading units 11 vibrate in the directions of both arrows A1 upon moving the cared person 101, a friction state between the cared person 101 and the oblique surfaces 11a as the contact areas to come into contact with the cared person 101 is constantly in a dynamic friction state. In this dynamic friction state, the frictional force is smaller as compared to the static state, wherefore the cared person 101 can be relatively easily transferred onto the transfer bed unit 13 as shown in FIGS. 2E and 2F via a state shown in FIGS. 2C and 2D without necessitating a large external force. Since the frictional force between the loading/unloading units 11 and the bed 102 also becomes a dynamic frictional force, the frictional force can be decreased. On the other hand, the cared person 101 can be unloaded by a similar operation, but in an opposite procedure.

As described above, according to this embodiment, the loading/unloading units 11 are vibrated in the directions of both arrows A1, whereby the friction between the cared person 101 and the bed 102 and the loading/unloading units 11 can become a dynamic friction to reduce a burden on a carer. Further, the cared person 101 can be safely handled since there is no need to expose a rotating mechanism or the like and there is no complicated surface structure in this embodiment.

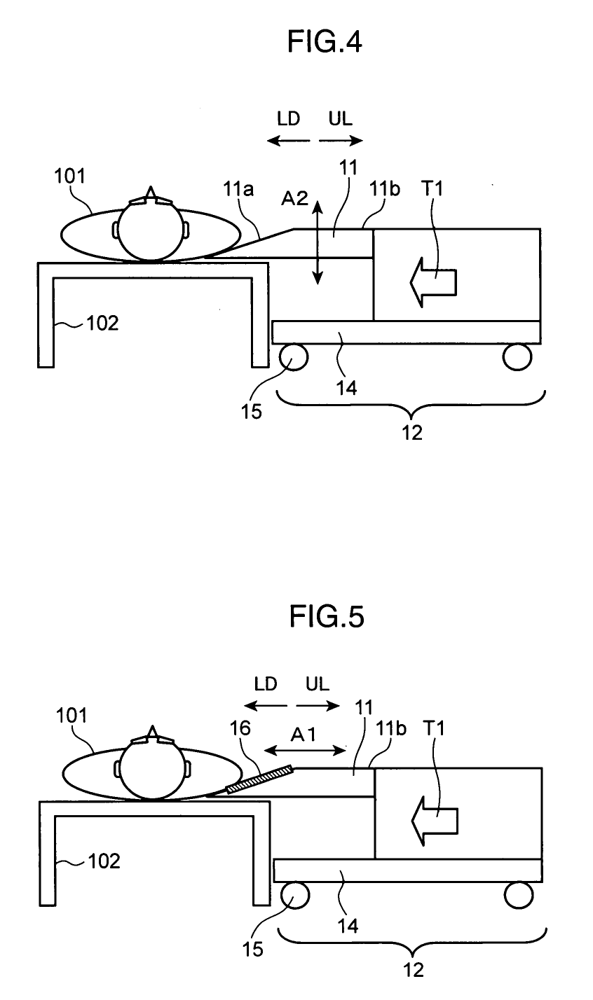

The vibration directions of the loading/unloading units 11 are not particularly limited to the above example, and the loading/unloading units 11 may be vibrated, for example, in directions of both arrows A2 that are a gravity direction and an antigravity direction normal to the load direction LD and the unload direction UL as shown in FIG. 4. Since the normal force changes upon microscopically entering the dynamic friction state in this case, there can be a moment when the frictional force is small and the cared person 101 can be easily moved. Alternatively, if it is assumed that a direction normal to the load direction at the left side in the horizontal plane is a leftward direction LL and a direction opposite to the leftward direction LL is a rightward direction LR as shown in FIG. 1A, the loading/unloading units 11 may be vibrated along these vibration directions. In this case as well, the burden on the carer can be reduced by making the friction between the cared person 101 and the bed 102 and the loading/unloading units 11 a dynamic friction. Effects similar to those of this embodiment can be obtained by vibrating the loading/unloading units 11 so as to contain components of at least one pair of vibration directions out of the load direction LD and unload direction UL, the gravity direction and antigravity direction A2, and the leftward direction LL and rightward direction RL.

The above vibration is effective upon loading the cared person 101 onto the loading/unloading units 11 or upon unloading the cared person 101 from the loading/unloading units 11, but the loading/unloading units 11 may be vibrated if necessary even in a normally loaded state where the cared person 101 is placed on the loading/unloading units 11.

Further, members having a specific function may be attached to the outer surfaces of the loading/unloading units 11. For example, as shown in FIG. 5, illustrated friction members 16 or the like may be provided for the adjustment of frictional forces if there is a possibility that the frictional forces become excessively small due to the vibration and the cared person 101 slides down the slope formed on the loading/unloading units 11 as in the case where it is wished to intermittently load the cared person 101. In this case, the slide-down of the cared person 101 can be prevented while the vibration is stopped.

### Second Embodiment

In a transfer apparatus according to a second embodiment of the present invention, vibration directions of contact areas of contact portions of loading/unloading units are changed at the time of loading a cared person and at the time of unloading the cared person, thereby realizing operations of loading and unloading the cared person with smaller loads. Similar to the first embodiment, this transfer apparatus is provided with at least two loading/unloading units.

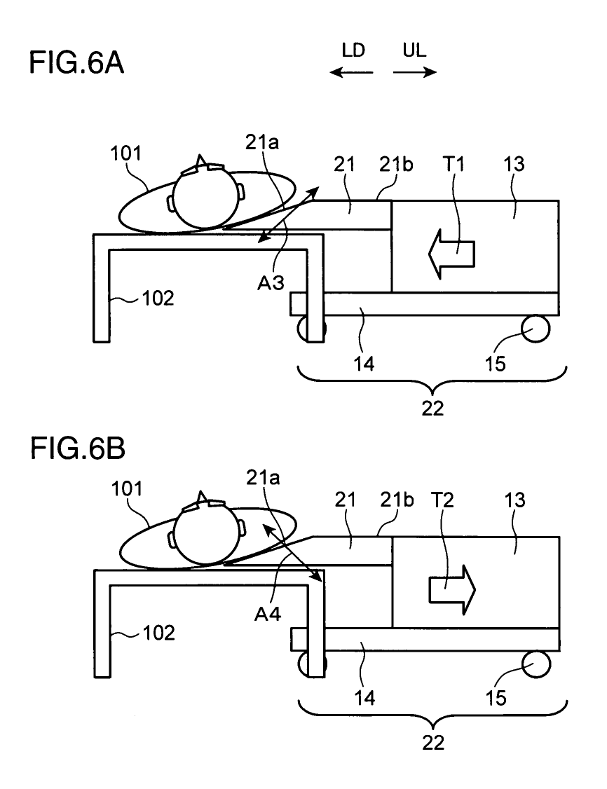

With reference to the drawings, the construction of the transfer apparatus of this embodiment and that of the loading/unloading units used in this transfer apparatus are described below. FIGS. 6A and 6B are schematic diagrams showing the construction of the transfer apparatus according to the second embodiment of the present invention, wherein FIG. 6A shows a state at the time of loading a cared person and FIG. 6B shows a state at the time of unloading the cared person. It should be noted that a cared person 101, a bed 102, leg portions 14, wheels 15 and arrows LD, UL and the like shown in FIGS. 6A and 6B are the same as in the first embodiment, and no detailed description is given thereon by identifying the same parts by the same reference numerals.

Each loading/unloading unit 21 includes an oblique surface 21a and an upper surface 21b that are integrally formed as contact portions having contact areas. Although the loading/unloading units 21 are constructed similar to the loading/unloading units 11 of the first embodiment, the vibration directions thereof differ. Although not shown, the transfer apparatus 22 is provided with two loading/unloading units 21 as in the first embodiment.

The loading/unloading units 21 are vibrated in directions of both arrows A3 (oblique upper right direction and oblique lower left direction) at the time of loading the cared person 101 as shown in FIG. 6A while being vibrated in directions of both arrows A4 (oblique upper left direction and oblique lower right direction) at the time of unloading the cared person as shown in FIG. 6B. The directions of both arrows A3 are an intermediate direction between a horizontal direction approximate to the load direction LD and the gravity direction and an intermediate direction between a horizontal direction approximate to the unload direction UL and the antigravity direction. The directions of both arrows A4 are an intermediate direction between a horizontal direction approximate to the load direction LD and the antigravity direction and an intermediate direction between a horizontal direction approximate to the unload direction UL and the gravity direction.

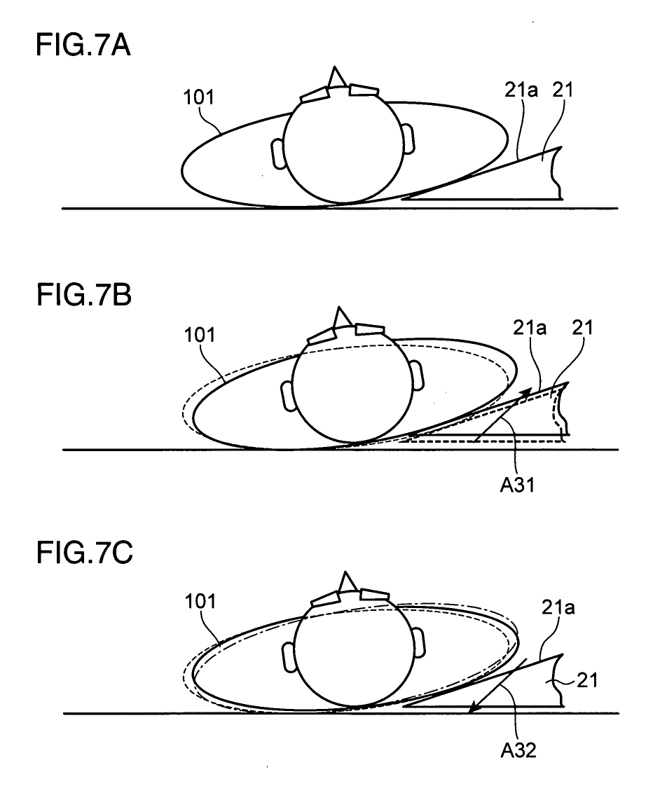

Next, the operation of the transfer apparatus 22 constructed as above is described. FIGS. 7A to 7C are schematic diagrams showing an operation of loading the cared person 101 on the loading/unloading units 21 shown in FIGS. 6A and 6B, wherein FIG. 7A shows a stationary state, FIG. 7B shows a state when the loading/unloading units 21 are moved in the direction A31 toward an antigravity side out of the directions of both arrows A3, and FIG. 7C shows a state when the loading/unloading units 21 are moved in the direction A32 toward a gravity side likewise out of the directions of both arrows A3.

When the loading/unloading units 21 are moved in the direction A31 toward the antigravity side as shown in FIG. 7B from the stationary state shown in FIG. 7A, normal forces to the oblique surfaces 21a increase by the counteraction caused by the inertia of the cared person 101 in response to an upward acceleration of the loading/unloading units 21, thereby increasing frictional forces. Thus, the cared person 101 moves from an initial state shown in broken line to a state shown in solid line by the frictional forces with the oblique surfaces 21a as the contact areas.

Subsequently, when the loading/unloading units 21 move in the direction A32 toward the gravity side as shown in FIG. 7C, the normal forces to the oblique surfaces 21a decrease by the inertia of the cared person 101 in response to a downward acceleration of the loading/unloading units 21, thereby decreasing frictional forces. Thus, the motion of the loading/unloading units 21 comes to possess horizontal components, but the motion of the cared person 101 substantially possesses hardly any horizontal component due to the small friction forces, thereby entering a state shown in solid line from a state shown in dashed-dotted line as shown in FIG. 7C.

As a result, the cared person 101 moves from the state shown in broken line to the state shown in solid line by the vibration of the loading/unloading units 21. In this way, the transfer apparatus 22 can advance in a direction of arrow T1 while insert the loading/unloading units 11 between the bed 102 and the cared person 101 to load the cared person 101 on the loading/unloading units 21 as shown in FIG. 6A. On the other hand, similar operations are realized by vibrating the transfer apparatus 22 in the directions of both arrows A4 as shown in FIG. 6B upon unloading the cared person 101.

As described above, according to this embodiment, the operations of loading and unloading the cared person 101 can be easily realized by vibrating the loading/unloading units 21 in the directions of both arrows A3 upon loading the cared person 101 on the loading/unloading units 21 and vibrating the loading/unloading units 21 in the directions of both arrows A4 upon unloading the cared person 101.

Depending on the situation, it is essential to insert the loading/unloading units 21 between the bed 102 and the cared person 101 at the time of loading the cared person 101 in some cases. In such cases, even an apparatus vibrating only in the directions of both arrows A3 can be practically used.

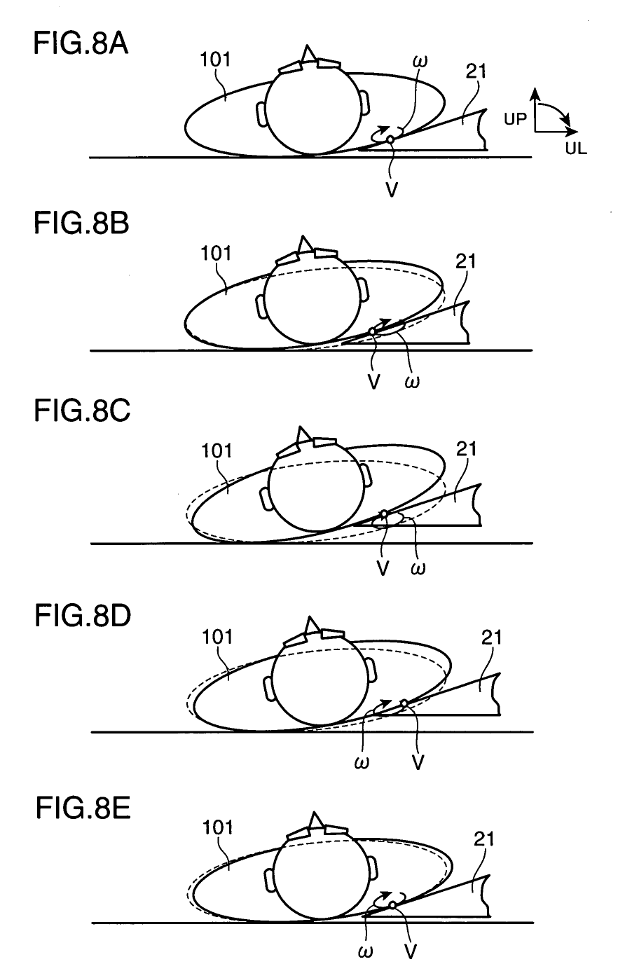

Further, as shown in FIGS. 8A to 8E, it is also effective to rotationally vibrate the loading/unloading units 21. FIGS. 8A to 8E show vibrating states upon loading the cared person 101. The loading/unloading units 21 are rotated in such a direction as to overlap a vector UP in the antigravity direction with a vector UL in the unload direction.

FIG. 8A shows an initial state, wherein V denotes an arbitrary point on the loading/unloading unit 21, to the motion of which attention is paid and ω denotes a locus representing the motion of the point V. FIGS. 8B to 8E show cases where the phase of ω is rotated at intervals of 90°. The initial state of the cared person 101 is shown in broken line in FIGS. 8B to 8E, from which it can be understood that the cared person 101 is moved in the unload direction UL by one turn of the loading/unloading units 21. In other words, when the entire transfer apparatus 22 advances in the direction of arrow T1, the loading/unloading units 21 are inserted in the load direction LD (see FIG. 6A). The unloading operation can be realized by reversing the rotating direction. Since the displacement of the cared person per amplitude is larger in the case of rotational vibration, the cared person can be loaded and unloaded within a shorter period of time.

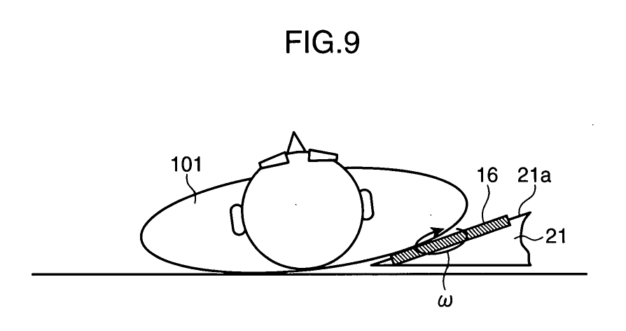

FIG. 9 shows an example in which the same friction members 16 as in the first embodiment are provided on the oblique surfaces 21 to increase traction forces in the unload direction UL by increasing the frictional forces in the contact areas. Effects similar to the above can also be obtained in this case.

### Third Embodiment

A transfer apparatus according to a third embodiment of the present invention is designed to realize operations of loading and unloading a cared person with smaller loads by changing the speed or acceleration of contact portions of loading/unloading units at the time of loading the cared person and at the time of unloading the cared person. Similar to the first embodiment, this transfer apparatus is provided with at least two loading/unloading units.

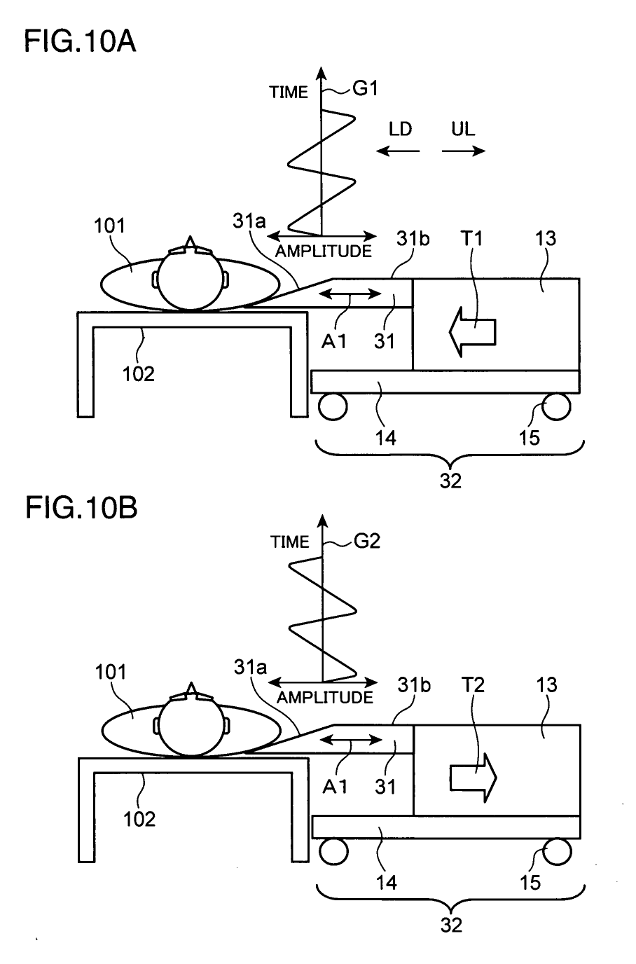

With reference to the drawings, the construction of the transfer apparatus of this embodiment and that of the loading/unloading units used in this transfer apparatus are described below. FIGS. 10A and 10B are schematic diagrams showing the construction of the transfer apparatus according to the third embodiment of the present invention, wherein FIG. 10A shows a state at the time of loading a cared person and FIG. 10B shows a state at the time of unloading the cared person. It should be noted that a cared person 101, a bed 102, leg portions 14, wheels 15 and arrows LD, UL and the like shown in FIGS. 10A and 10B are the same as in the first embodiment, and no detailed description is given thereon by identifying the same parts by the same reference numerals.

Each loading/unloading unit 31 includes an oblique surface 31a and an upper surface 31b that are integrally formed as contact portions having contact areas. Although the loading/unloading units 31 are constructed similar to the loading/unloading units 11 of the first embodiment and are vibrated in directions of both arrows A1 as in the first embodiment, a vibration mode is different. Although not shown, a transfer apparatus 32 is provided with two loading/unloading units 31 as in the first embodiment.

As shown in FIG. 10A, the loading/unloading units 31 make a zigzag movement as shown in a graph G1 of time and amplitude at the time of loading a cared person 101. An inclination to the time axis of this graph G1 represents a vibration speed. In other words, the vibration speed differs in the load direction LD and the unload direction UL, and a faster movement is made in the load direction. In this way, states approximate to that of a static friction coefficient and states approximate to that of a dynamic friction coefficient can be created by one cycle of vibration, and the cared person 101 can slide down the oblique surfaces 31a when dynamic frictional forces act. Similarly, the relationship of the vibration speed and the direction is reversed as shown in FIG. 10B upon unloading the cared person.

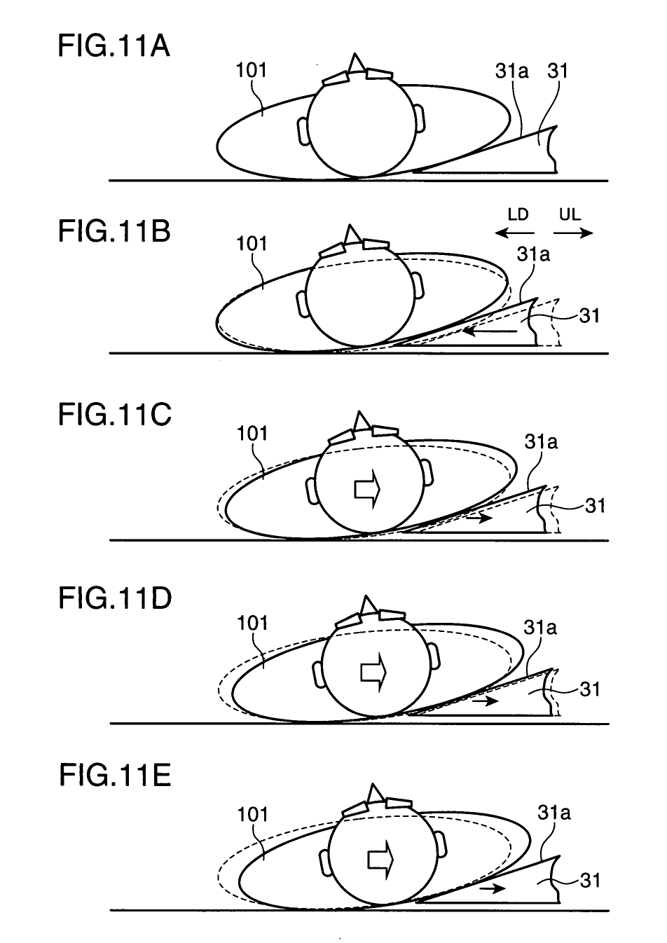

Next, the operation of the transfer apparatus 32 constructed as above is described. FIGS. 11A to 11E are schematic diagrams showing an operation of loading the cared person 101 on the loading/unloading units 31 shown in FIGS. 10A and 10B, wherein FIG. 11A shows a stationary state, and FIGS. 11B to 11E show operating states of the loading/unloading units 31. It should be noted that initial positions of the loading/unloading units 31 and the cared person 101 are shown in broken line in FIGS. 11B to 11E.

First, when the loading/unloading units 31 move at higher speed in the load direction LD as shown in FIG. 11B from the stationary state shown in FIG. 11A, the cared person 101 is hardly displaced in the load direction LD since the frictional forces are dynamic frictional forces and the loading/unloading units 31 are inserted between the cared person 101 and the bed 102. Then, when the loading/unloading units 31 are moved in the unload direction UL at lower speed as shown in FIGS. 11C to 11E, large frictional forces act and the cared person 101 can be moved in the unload direction UL since the frictional forces are static frictional forces. In this way, the loading operation can be continued. The operation of unloading the cared person is realized by reversing the relationship of the vibration speed and the direction.

As described above, according to this embodiment, the operations of loading and unloading the cared person 101 can be selectively realized by changing the vibration speed of the loading/unloading units 31 in the load direction and in the unload direction, i.e. the directions of arrows A1. Although the vibration directions are the load direction LD and the unload direction UL, it is all right to set these vibration directions substantially in parallel with the oblique surfaces 31a. Further, the friction members 16 of FIG. 9 or the like may be arranged on the oblique surfaces 31a if necessary.

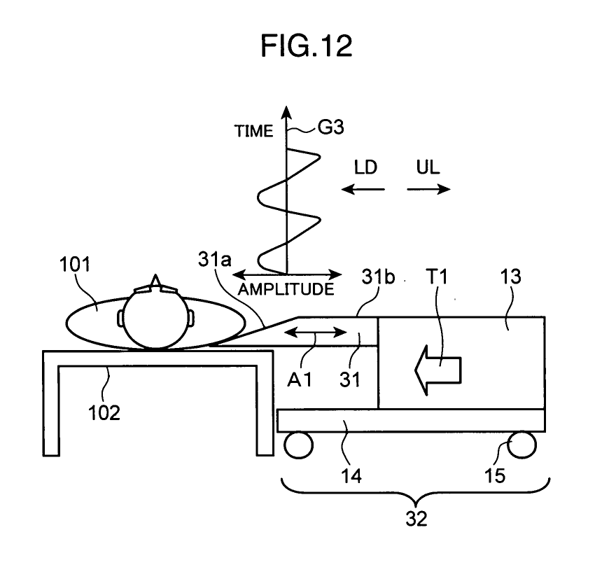

Further, as in an example shown in FIG. 12, the loading operation can be more effectively performed by differentiating the vibration accelerations in addition to differentiating the vibration speeds. It can be understood from a graph G3 that vibration acceleration in the unload direction UL is smaller than vibration acceleration in the load direction LD. Therefore, an inertial force at the time of a direction switch decreases and the slide-down of the cared person 101 in the load direction LC at the time of the loading operation can be suppressed.

### Fourth Embodiment

A transfer apparatus according to a fourth embodiment of the present invention is designed to realize operations of loading and unloading a cared person by switching contact portions of loading/unloading units to members having different friction coefficients in a load direction and in an unload direction at the time of loading and unloading the cared person. Similar to the first embodiment, this transfer apparatus is provided with at least two loading/unloading units.

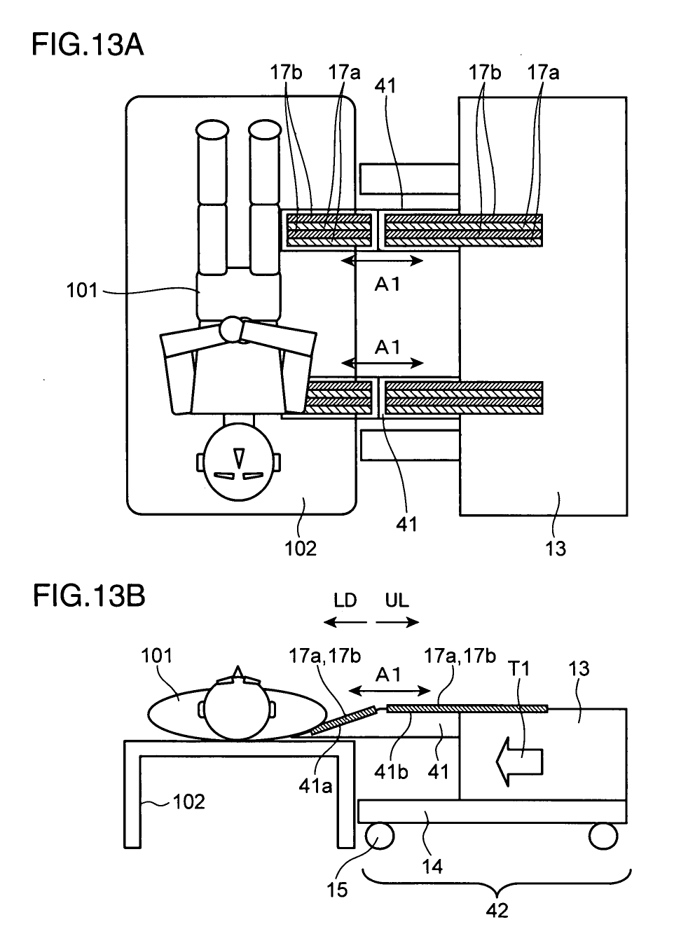

With reference to the drawings, the construction of the transfer apparatus of this embodiment and that of the loading/unloading units used in this transfer apparatus are described below. FIGS. 13A and 13B are schematic diagrams showing the construction of the transfer apparatus according to the fourth embodiment of the present invention, wherein FIG. 13A is a plan view and FIG. 13B is a side view. It should be noted that a cared person 101, a bed 102, leg portions 14, wheels 15 and arrows LD, UL and the like shown in FIGS. 13A and 13B are the same as in the first embodiment, and no detailed description is given thereon by identifying the same parts by the same reference numerals.

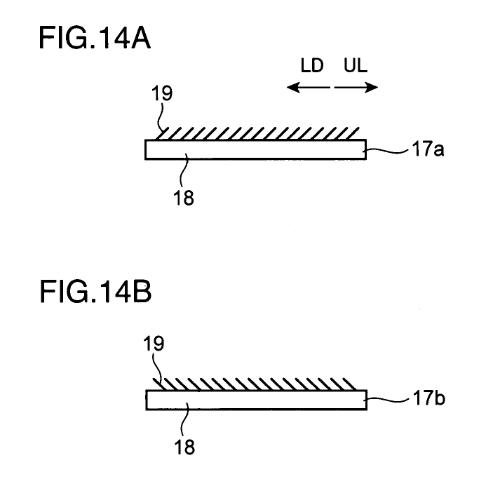

Each loading/unloading unit 41 includes elastic fiber boards 17a, 17b as contact members, which are contact portions having contact areas, on an oblique surface 41a and an upper surface. As shown in FIGS. 14A and 14B, the elastic fiber boards 17a, 17b are the same objects, but differ in the mounted orientation on the oblique surface 41a and the upper surface 41b. The construction of each elastic fiber board 17a, 17b is such that fibrous materials 19 (one example of fibrous elastic bodies) made of elastic bodies are arranged in one direction on the upper surface of a rigid plate 18. The fibrous materials 19 made of elastic bodies can be selected from various fiber-like materials including, for example, nylon fibers, acrylic fibers and carbon fibers.

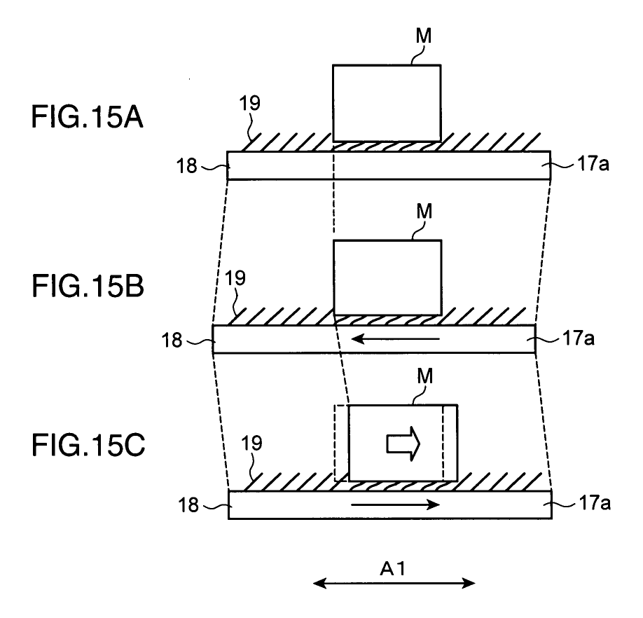

A movement of an object by a movement of this elastic fiber board 17a is shown in FIGS. 15A to 15C, wherein FIG. 15A shows a stationary state, FIG. 15B shows a state when the elastic fiber board 17a is moved to left and FIG. 15C shows a state when the elastic fiber board 17a is moved to right.

First, as shown in FIG. 15A, the fibrous materials 19 below the object M are elastically deformed due to the weight of the object M. Here, when the elastic fiber board 17a moves to left with acceleration as shown in FIG. 15B, an inertial force acts on the object M, which tries to stay there. Since the fibrous materials 19 are arranged with such directivity that the object M can be easily displaced to right in FIGS. 15A to 15C, only the elastic fiber board 17a moves to left. On the other hand, when the elastic fiber board 17a moves to right with acceleration as shown in FIG. 15C, an inertial force acts on the object M, which tries to stay there. However, since the fibrous materials 19 are arranged in a direction to be engaged with the object M as shown, the object M moves together with the elastic fiber board 17a. In this way, the object M can be moved in one direction with symmetric vibration by an object having asymmetric friction coefficient like the elastic fiber board 17a.

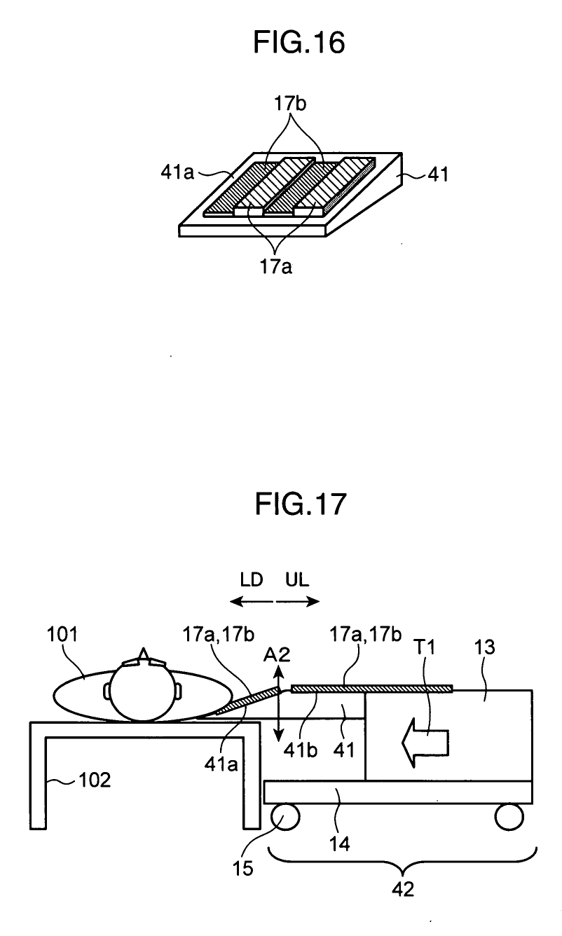

The detailed arrangement of these elastic fiber boards 17a, 17b on the oblique surface 41a is shown in FIG. 16. In the elastic fiber boards 17a, the fibrous materials 19 are so arranged as to reduce the friction coefficient when an object moves in the unload direction UL. In the elastic fiber boards 17b, the fibrous materials 19 are so arranged as to reduce the friction coefficient when an object moves in the load direction LD. Each loading/unloading unit 41 is internally provided with a mechanism for switching projecting amounts of the elastic fiber boards 17a, 17b depending on the purpose. FIG. 16 shows a state where the elastic fiber boards 17a project for the loading operation to come into contact with the cared person 101. It should be noted that a construction similar to the above is also provided on the upper surfaces 41b as shown in FIG. 13A.

Further, as shown in FIGS. 13A and 13B, the vibration direction of the loading/unloading units 41 are directions of both arrows A1 as in the first embodiment. The transfer apparatus 42 includes two loading/unloading units 41 as in the first embodiment. Upon unloading the cared person 101, the elastic fiber boards 17b are caused to project and the loading/unloading units 41 are vibrated in the directions of both arrows A1.

The operations of the loading/unloading units 41 and the transfer apparatus 42 of this embodiment are not described because being similar to those of the third embodiment. The operations of loading and unloading the cared person 101 can be selectively realized by switching the elastic fiber boards 17a, 17b upon the symmetric vibration in the directions of both arrows A1. Although the vibration directions are the directions of both arrows A1, it is all right to set these vibration directions substantially in parallel with the oblique surfaces 41a.

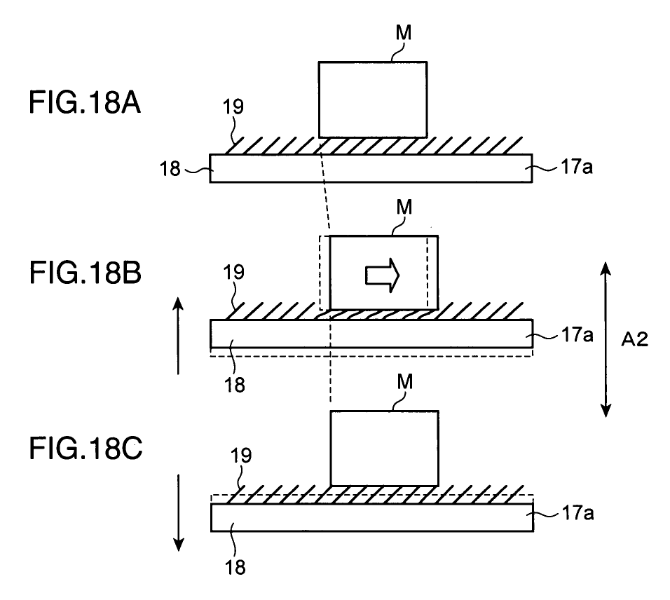

Further, similar functions can be realized even if the loading/unloading units 41 are vibrated, for example, in directions of both arrows A2 that are a gravity direction and an antigravity direction as shown in FIG. 17. When the elastic fiber board 17a is accelerated upward to enter a stare shown in FIG. 18B from a stationary state shown in FIG. 18A, the fibrous materials 19 are elastically buckled and deformed by an inertial force, and the object M being led and engaged with the fibrous materials 19 is displaced rightward that is a buckling direction. When the elastic fiber board 17a is accelerated downward as shown in FIG. 18C, the fibrous materials 19 are elastically restored, but loads exerted to the fibrous materials 19 are reduced by the acceleration of the object M, thereby loosening up the engaged state. Thus, the upper ends of the fibrous materials 19 slip on the bottom surface of the object M, wherefore the object M is not displaced. In this way, the operations of loading and unloading the cared person 101 can be realized even in the case of vibration in the directions of both arrows A2.

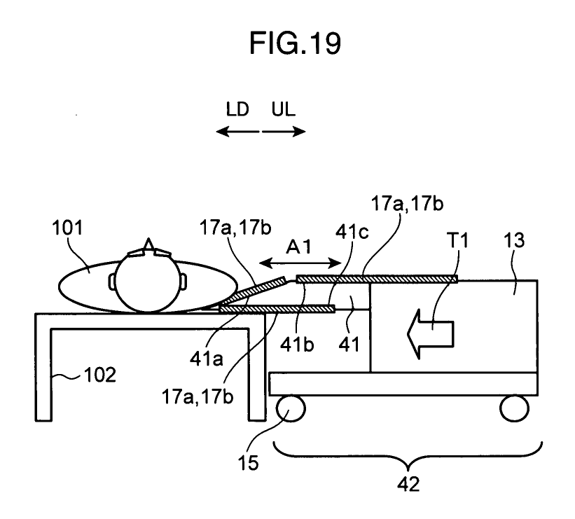

Further, the elastic fiber boards 17a, 17b may be arranged on bottom surfaces 41c of the loading/unloading units 41 as shown in FIG. 19. This can reduce frictional resistance between the loading/unloading units 41 and the bed 102.

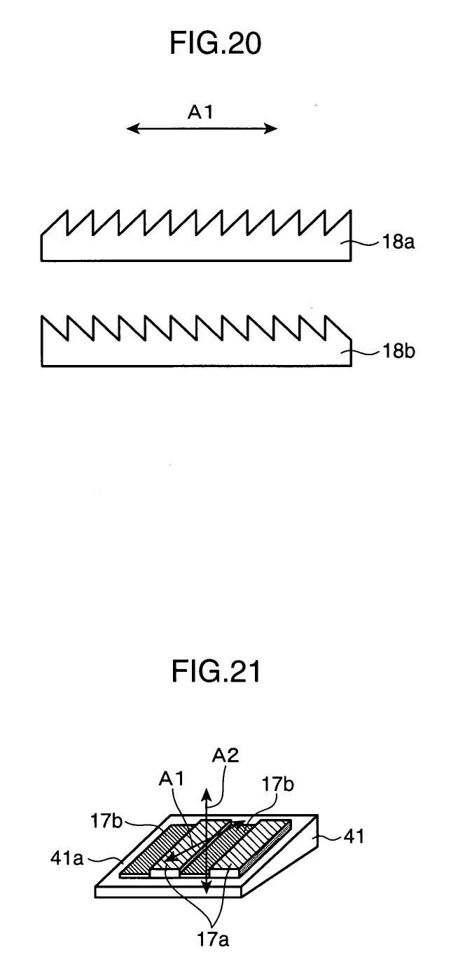

Instead of the elastic fiber boards 17a, 17b as the contact members, serrated boards 18a, 18b whose cross-sections parallel to a plane including the load direction LD and the unload direction UL have serrated shapes asymmetric with respect to the gravity direction as shown in FIG. 20. The serrated board 18a has slants extending along an oblique direction between the antigravity direction and the unload direction UL, i.e. slants extending along the direction of the fibrous materials 19 of the elastic fiber board 17a, and the serrated board 18b has slants extending along an oblique direction between the antigravity direction and the load direction LD, i.e. slants extending along the direction of the fibrous materials 19 of the elastic fiber board 17b. Thus, the serrated boards 18a, 18b can operate similar to the elastic fiber boards 17a, 17b to obtain similar effects.

Further, only the elastic fiber boards 17a, 17b as the contact members may, for example, be vibrated relative to the loading/unloading units 41 as shown in FIG. 21. In this case as well, effects can be obtained regardless of whether the vibration directions are the directions of both arrows A1 or the directions of both arrows A2 since the friction coefficients of the elastic fiber boards 17a, 17b are anisotropic. Similar effects can be obtained even if the vibration directions are combined directions of these directions. This construction has a higher energy efficiency since the movable portions have small masses.

Although the elastic fiber boards 17a as the contact members suitable for the loading operation and the elastic fiber boards 17b as the contact members suitable for the unloading operation are used in this embodiment, it is also possible to use contact members that function to have a different anisotropy, for example, upon an electrical input other than being used in a switched manner. Such minute actuators can be realized, for example, using MEMS (micro-electro-mechanical systems) actuators.

Although the effects of the elastic fiber boards 17a as the contact members suitable for the loading operation and the elastic fiber boards 17b as the contact members suitable for the unloading operation are set equal in this embodiment, any suitable change such as an increase of the areas of the elastic fiber boards 17a used for the loading operation can be made according to needs if the load during the loading operation is larger than the one during the unloading operation.

Since the elastic fiber boards 17a, 17b as the contact members have a possibility of being abraded, it is advantageous in light of maintenance or the like if they are constructed to be detachable. Further, since these contact members have a possibility of being charged due to frequent friction with cared people, usability is improved by applying an antistatic finish to the contact members, for example, by making the contact members of a conductive material and grounding them.

### Fifth Embodiment

A transfer apparatus according to a fifth embodiment of the present invention is designed to realize a transfer apparatus for detecting the posture of a cared person and stably loading the cared person.

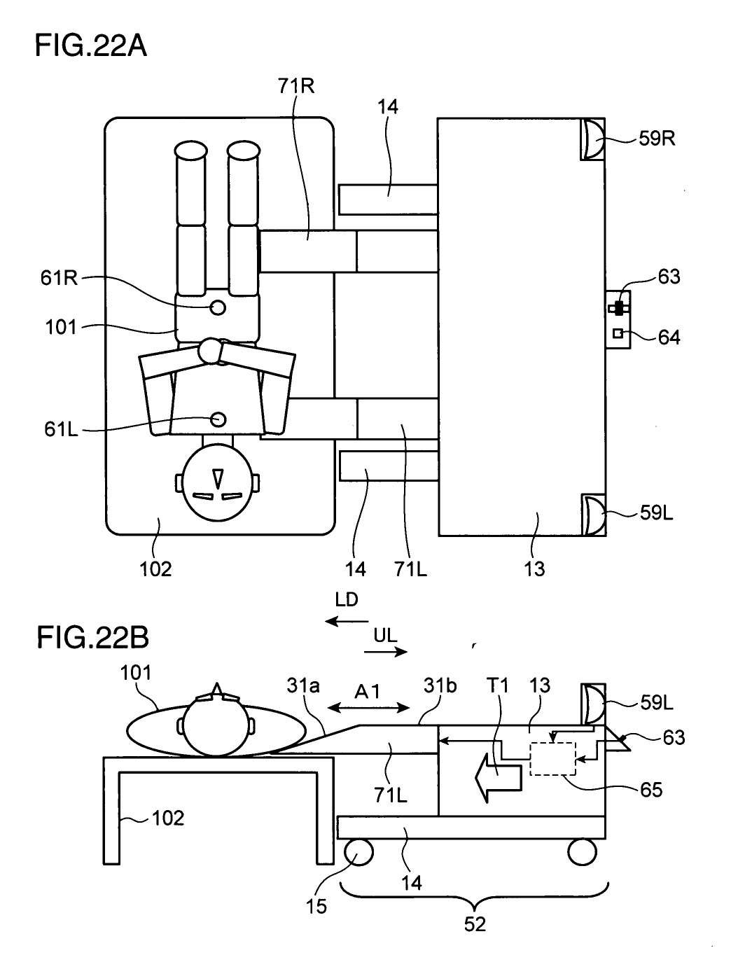

With reference to the drawings, the construction of the transfer apparatus of this embodiment is described below. FIGS. 22A and 22B are schematic diagrams showing the construction of the transfer apparatus according to the fifth embodiment of the present invention, wherein FIG. 22A is a plan view and FIG. 22B is a side view.

A cared person 101, a bed 102, a transfer bed unit 13, leg portions 14, wheels 15 and arrows LD, UL and the like are the same as in the first embodiment, and no detailed description is given thereon by identifying the same parts by the same reference numerals. Further, loading/unloading units 71R, 71L are the same as the loading/unloading units 31 used in the third embodiment, but are individually distinguished therefrom for the sake of convenience.

Distance sensors 59R, 59L are equipped in the transfer bed unit 13. Two markers 61L, 61R are mounted on the median line of the cared person 101 or in a direction parallel to the backbone. These markers 61L, 61R can be easily mounted by means of clips or the like as long as they will not come off by vibration or the like.

The respective distance sensors 59R, 59L can output distances to the respective markers 61L, 61R in the form of electrical signals. These distance sensors 59R. 59L may in principle adopt various methods, for example, for detecting reflection times of lights, response times of infrared rays, the reflection of ultrasonic waves, etc.

A power switch 64 is a switch used to turn a transfer apparatus 52 on and off. A slider 63 is used to input the loaded position of the cared person 101. A set value of this slider 63 and the outputs of the distance sensors 59R, 59L are inputted to a system controller 65 built in the transfer bed unit 13 to be described later, and the system controller 65 drives and vibrates the loading/unloading units 71R, 71R using drive amplifiers to be described later and the like. The transfer apparatus 52 is constructed from the above respective members.

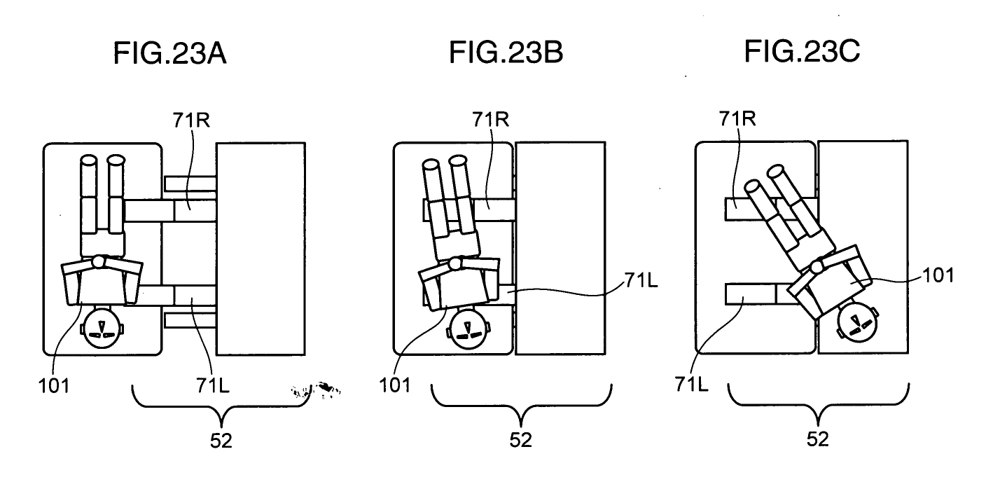

This embodiment is designed to moderate a possibility of inclining the cared person 101 by vibration as shown in FIGS. 23A to 23C upon transferring the cared person 101 as shown in FIGS. 22A and 22B. Various causes of this inclination can be thought. For example, since parts of the cared person 101 supported by the loading/unloading units 71L, 71R differ, friction coefficients naturally differ. Further, normal forces differ at the head side and the leg side, thereby causing a difference in frictional forces. Furthermore, since the surface state or the like of the bedclothes also differs, a difference in frictional forces can become a large difference.

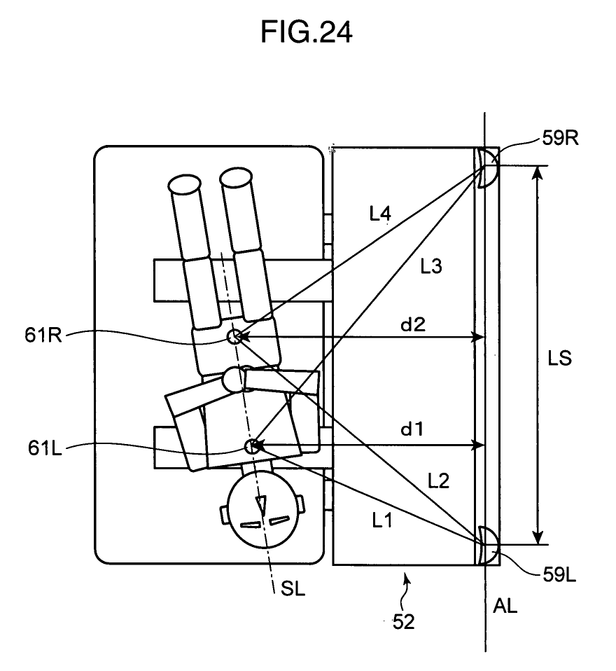

With reference to FIG. 24, the operations of the distance sensors 59L, 59R are described. For example, distances from the distance sensor 59L to the markers 61L, 61R are respectively measured to be L1, L2, and distances from the distance sensor 59R to the markers 61L, 61R are respectively measured to be L3, L4. Since a distance between the distance sensors 59L, 59R along a measurement baseline AL of the transfer apparatus 52 is determined to be shown distance LS, a distance d1 between the marker 61L and the baseline AL can be geometrically calculated from lengths L1, L3, LS of the respective sides of a triangle. A distance d2 between the marker 61R and the baseline AL can be similarly calculated. Further, a relative angle between the median line SL of the cared person and the baseline AL can also be obtained.

Here, a difference d2-d1 of the distances d1, d2 corresponds to one example of inclination information corresponding to a relative angle between a direction of the backbone of the cared person lying on his back and the load direction LD or the unload direction UL. These calculations are carried out by the system controller 65 shown in FIG. 22.

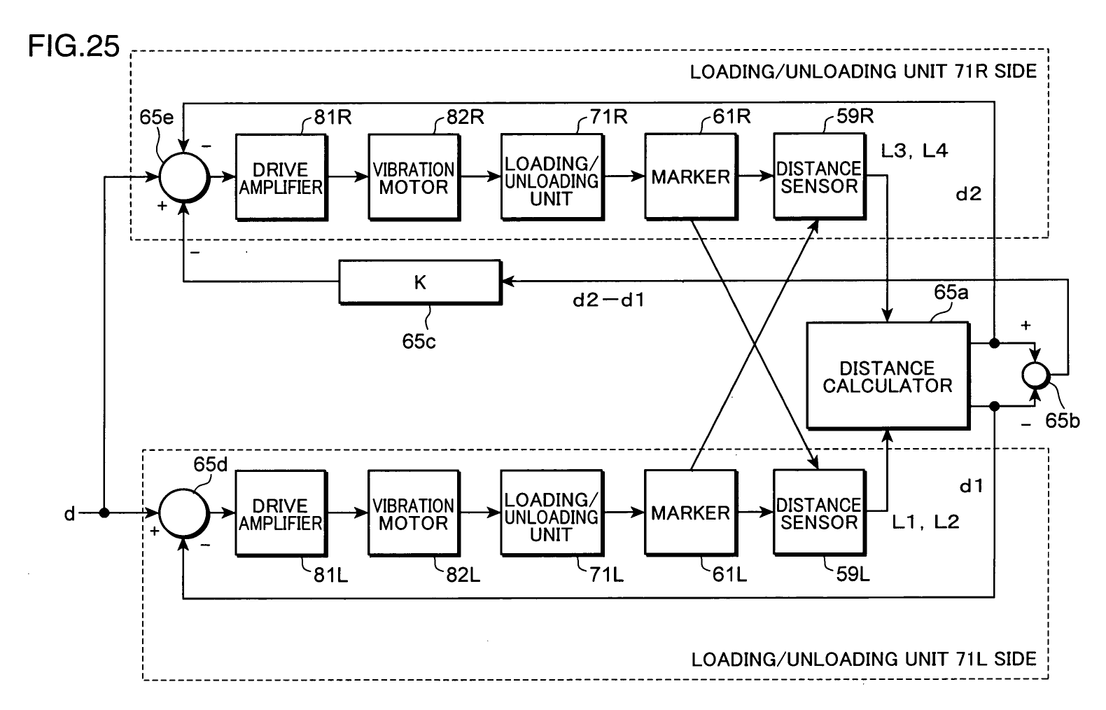

FIG. 25 is a block diagram showing the electrical construction of the transfer apparatus 52 shown in FIGS. 22A and 22B. The system controller 65 includes a distance calculator 65a, subtractors 65b, 65d, 65e and a processor 65, controls operations between the loading/unloading units 71L, 71R and operates signals. The loading/unloading units 71L, 71R can be independently driven.

At a loading/unloading unit 71L side, a target distance d inputted from the slider 63 is inputted to a drive amplifier 81L, fed as a current value from the drive amplifier 81L to a vibration motor 82L, thereby becoming the vibration of the loading/unloading unit 71L (oblique surface 31a and upper surface 31b) and causing displacements of the markers 61L, 61R of the cared person 101. Such displacements are inputted to the distance sensor 59L and the distances between the distance sensor 59L and the markers 61L, 61R are respectively outputted as L1, L2 from the distance sensor 59L. Similarly, at a loading/unloading unit 71R side, the distances between the distance sensor 59L and the markers 61L, 61R are respectively outputted as L3, L4.

Using the distances L1 to L4, the distance d1 between the marker 61L and the baseline AL and the distance d2 between the marker 61R and the baseline AL are calculated by the distance calculator 65a of the system controller 65, and fed back to the subtractors 65d, 65e of the system controller 65 to be subtracted from the target distance d, thereby being negatively fed back to the loading/unloading unit 71L side and the loading/unloading unit 71R side.

Further, the distances d1, d2 are inputted to the subtractor 65b of the system controller 65, and the difference d2−d1 is calculated, fed back to the subtractor 65e after a processing K in the processor 65c of the system controller 65, and further subtracted from the target distance d, thereby being negatively fed back to the loading/unloading unit 71R side. This processing K requires a suitable proportional gain K. Besides it, an integral element may be inputted to stabilize resistance to signal noise such as the swings of the markers or external interference.

The operation of the transfer apparatus 52 constructed as above is described below. In FIGS. 22A and 22B, a target loading position is inputted by means of the slider 63 at the time of loading the cared person 101. Then, the target distance d shown in FIG. 25 is set, and inputs to the drive amplifiers 81L, 81R are determined based on a distance between the present distances d1, d2, whereby the vibration motors 82L, 82R move to vibrate the contact portions (integral to the loading/unloading units 71L, 71R in this example). As a result, the markers 61L, 61R move, the distance sensors 59L, 59R output the distances L1 to L4 to the markers 61L, 61R, and the distances d1, d2 shown in FIG. 24 are calculated in the distance calculator 65a.

At the loading/unloading unit 71L side, an input signal based on a difference d−d1 is inputted to the drive amplifier 81L since the distance d1 is negatively fed back. Similarly, a signal based on a difference d−d2 is inputted to the drive amplifier 81R at the loading/unloading unit 71R side. Further, an input on the distance different d2−d1 is made only to the loading/unloading unit 71R side. By this feedback term, a component resulting from the inclination of the cared person 101 can be suppressed by an amount corresponding to K during the loading operation, wherefore the transfer apparatus 52 can more safely operate. Finally, d1=d and d2=d are reached, whereby d2−d1=0 and the inputs to the drive amplifiers 81L, 81R become 0 to complete the operation. The operation of unloading the cared person can be realized by a reverse operation.

As describe above, according to this embodiment, the inclination of the cared person 101 upon being loaded or unloaded can be suppressed by feeding the distances detected by the distance sensors 59L, 59R, inclination and the like back to the loading/unloading units 71L, 71R.

Although the loading/unloading units 71L, 71R are the same as the loading/unloading units 31 used in the third embodiment in this embodiment, they may be, of course, different loading/unloading units. In such a case, loading/unloading units having suitable vibration directions may be selected. Instead of using the distance sensors, the distances d1, d2 may be calculated by detecting angles at which the markers are viewed or the distances and angles to the markers may be detected by stereo vision.

Although the input device is the slider 63, another method may be, of course, adopted. For example, an input may be made by switching between two fixed points. Further, although the input based on the distance difference d2−d1 is given to the loading/unloading unit 71R side, it may be given to the loading/unloading unit 71L side. It is sufficient to enter this input while paying attention to a sign at either one of these sides. Although signals inputted to the drive amplifiers 81R, 81L are not described in detail, the amplitude, frequency or the like of the vibration corresponds to these signals. If the vibration system utilizes resonance, amplitude increases in the vicinity of a resonant frequency. Thus, this phenomenon can also be utilized upon changing the frequency.

### Sixth Embodiment

A transfer apparatus according to a sixth embodiment of the present invention includes transport intermediates that make (apparent) friction states on contact surfaces between a cared person to be transported and contact portions of loading/unloading units variable, and is designed to smoothly insert and withdraw the loading/unloading units by reducing friction between the cared person and the loading/unloading units upon transferring the cared person from or to the loading/unloading units and to stably hold the cared person so that the cared person is not deviated from an intended position or does not slip down by increasing friction while the cared person is held on the loading/unloading units.

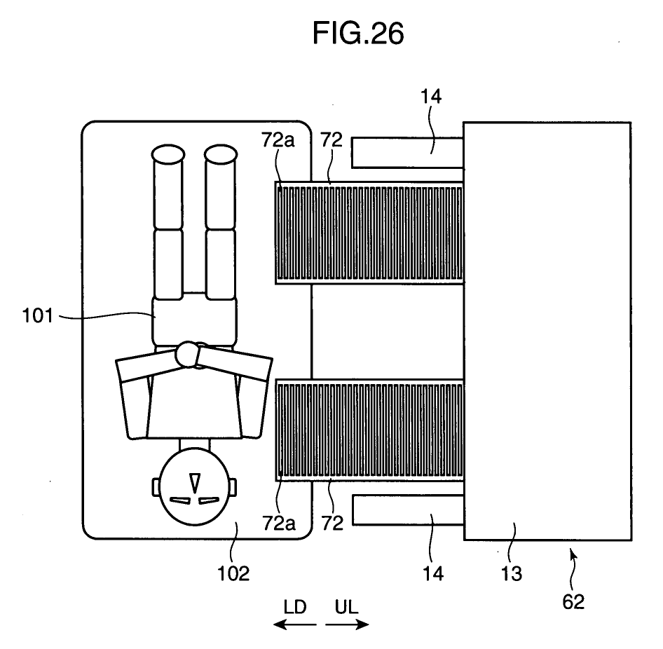

With reference to the drawings, the construction of the transfer apparatus of this embodiment is described below. FIG. 26 is a schematic diagram showing the construction of the transfer apparatus according to the sixth embodiment of the present invention. In the sixth embodiment, the same parts as in the first embodiment are identified by the same reference numerals and are not described in detail.

As shown in FIG. 26, a transfer apparatus 62 is provided with two loading/unloading units 72 each including a plurality of cylindrical rollers 72a, wherein the plurality of rollers 72a are arranged one after another along a load direction LD (or an unload direction UL). For example, rollers having a small diameter of about 1 to 2 mm can be used as the rollers 72a.

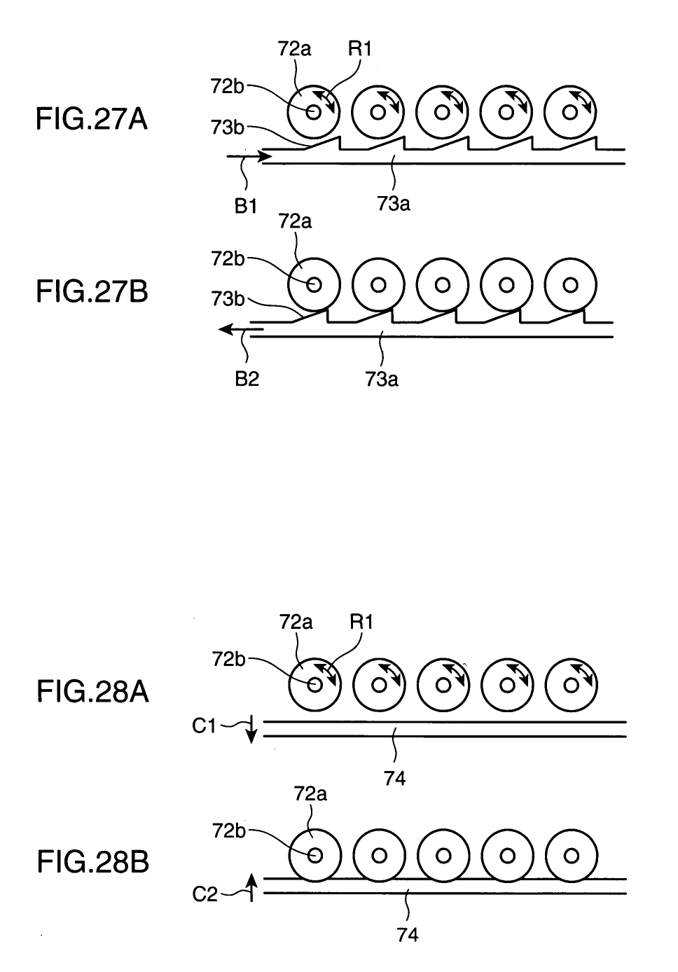

FIGS. 27A and 27B are diagrams showing states at the times of low friction and high friction of the rollers 72a shown in FIG. 26. The rollers 72a are supported rotatably in rotating directions R1 on rotary shafts 72b fixed to the loading/unloading unit 72, and a slide member 73a is supported on the loading/unloading unit 72 slidably in moving directions B1, B2 along a horizontal direction. The slide member 73a is formed with a plurality of projections 73b having slants, and these projections 73b function as wedges.

First, at the time of low friction, the slide member 73a is moved in the moving direction B1 by an unillustrated driving portion such as a solenoid to be distanced from the rollers 72a as shown in FIG. 27A, thereby making the rollers 72a rollable. Thus, a friction state between the cared person 101 and the rollers 72a, i.e. the loading/unloading unit 72 becomes a low friction state, wherefore the loading/unloading unit 72 can be smoothly inserted and withdrawn.

On the other hand, at the time of high friction, the slide member 73a is moved in the moving direction B2 by the unillustrated driving portion such as a solenoid, whereby the rollers 72a and the slants of the projections 73b are engaged and the slide member 73a stops the rotation of the rollers 72a as shown in FIG. 27B. Thus, a friction state between the cared person 101 and the rollers 72a, i.e. the loading/unloading unit 72 becomes a high friction state, wherefore the cared person 101 can be transferred while being stably placed on the loading/unloading unit 72.

The rollers 72a and the slide member 73a are, for example, made of soft resin or the like and easily deformed along the body shape of the cared person 101 when the loading/unloading unit 72 is inserted and withdrawn and the cared person 101 is loaded. Thus, the loading/unloading unit 72 can be more smoothly inserted and withdrawn and a burden on the cared person 101 during the loading operation can be reduced.

FIGS. 28A and 28B are schematic diagrams showing states at the times of low friction and high friction of other rollers 72a usable in the loading/unloading units 72 shown in FIG. 26. The rollers 72a are supported rotatably in rotating directions R1 on rotary shafts 72b fixed to the loading/unloading unit 72, and a slide member 74 is a flat lifting plate supported on the loading/unloading unit 72 vertically movably in moving directions C1, C2 along a vertical direction.

First, at the time of low friction, the slider member 74 is moved downward in the moving direction C1 by an unillustrated driving portion such as a solenoid to be distanced from the rollers 72a as shown in FIG. 28A, thereby making the rollers 72a rollable. Thus, a friction state between the cared person 101 and the rollers 72a, i.e. the loading/unloading unit 72 becomes a low friction state, wherefore the loading/unloading unit 72 can be smoothly inserted and withdrawn.

On the other hand, at the time of high friction, the slide member 74 is moved upward in the moving direction B2 by the unillustrated driving portion such as a solenoids, whereby the rollers 72a and the upper surface of the slide member 74 are engaged and the slide member 74 stops the rotation of the rollers 72a as shown in FIG. 28B. Thus, a friction state between the cared person 101 and the rollers 72a, i.e. the loading/unloading unit 72 becomes a high friction state, wherefore the cared person 101 can be moved while being stably placed on the loading/unloading unit 72.

Although the upper surface of the slide member 74 is described to be flat in this example, the friction coefficient may be increased by applying knurling or the like to the upper surface of the slide member 74 to make this upper surface uneven or by using a plate member having a high friction coefficient as the slide member 74 without being particularly limited to this example. By doing so, the rotation of the rollers 72a can be strongly stopped and a higher friction state can be attained.

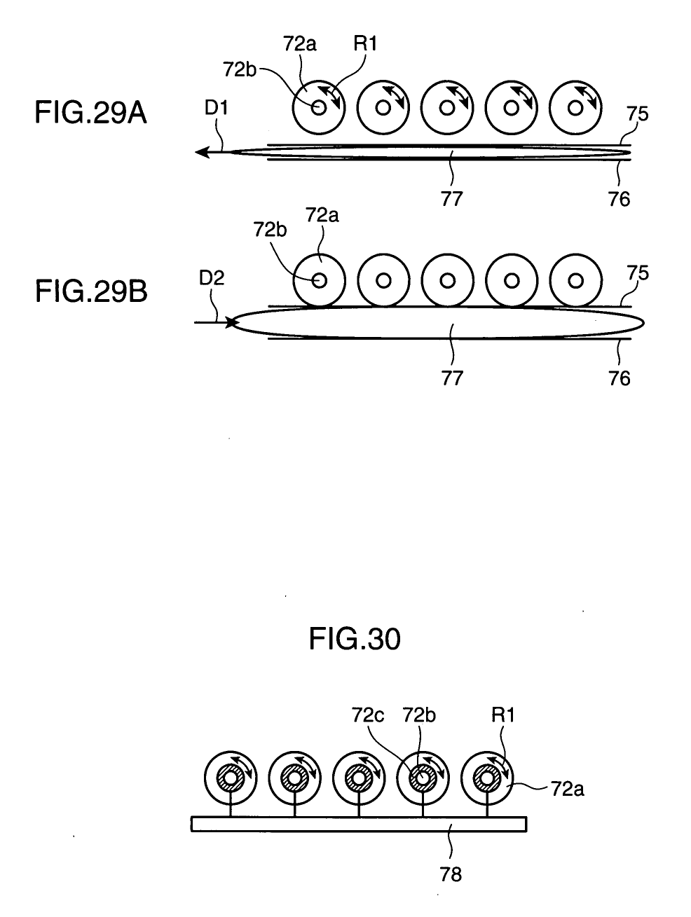

FIGS. 29A and 29B are schematic diagrams showing states at the times of low friction and high friction of other rollers 72a usable in the loading/unloading units 72 shown in FIG. 26. The rollers 72a are supported rotatably in rotating directions R1 on rotary shafts 72b fixed to the loading/unloading unit 72, and an airbag 77 is held between a ceiling plate 75 and a bottom plate 76, and the ceiling plate 75, the bottom plate 76 and the airbag 77 are mounted on the loading/unloading unit 72 in such a state that the ceiling plate 75 can move upward and downward as the airbag 77 expands and shrinks.

First, at the time of low friction, the airbag 77 shrinks, the ceiling plate 75 is moved downward to be distanced from the rollers 72a, thereby making the rollers 72a rollable as shown in FIG. 29A when air inside the airbag 77 is exhausted in an exhaust direction D1 by an unillustrated driving portion such as a pump. Thus, a friction state between the cared person 101 and the rollers 72a, i.e. the loading/unloading unit 72 becomes a low friction state, wherefore the loading/unloading unit 72 can be smoothly inserted and withdrawn.

On the other hand, at the time of high friction, the airbag 77 expands, the ceiling plate 75 is moved upward and engaged with the rollers 72a to stop the rotation of the rollers 72a as shown in FIG. 29B when air is taken into the airbag 77 along an intake direction D2 by the unillustrated driving portion such as a pump. Thus, a friction state between the cared person 101 and the rollers 72a, i.e. the loading/unloading unit 72 becomes a high friction state, wherefore the cared person 101 can be moved while being stably placed on the loading/unloading unit 72.

Although the upper surface of the ceiling plate 75 is described to be flat in this example, the friction coefficient may be increased by applying knurling or the like to the upper surface of the ceiling plate 75 to make this upper surface uneven or by using a plate member having a high friction coefficient as the ceiling plate 75 without being particularly limited to this example. By doing so, the rotation of the rollers 72a can be strongly stopped, and a higher friction state can be attained.

FIG. 30 is a schematic diagram showing states at the times of low friction and high friction of other rollers 72a usable in the loading/unloading units 72 shown in FIG. 26. The rollers 72a are supported rotatably in rotating directions R1 on rotary shafts 72b fixed to the loading/unloading unit 72, a variable viscosity fluid 72c is sealed between the rollers 72a and the rotary shafts 72b, and the rotary shafts 72b are fixed to bearing fixing portions 78 provided on the transfer unit 72.

An electrorheological fluid whose apparent viscosity changes upon the application of a voltage is used as the variable viscosity fluid 72c. A variable viscosity fluid having variable viscosity is not particularly limited to this example, and another variable viscosity fluid such as a magnetic fluid or MR (magneto-rheological) fluid may be provided between the rollers 72a and the rotary shafts 72b to control viscosity resistance to the rolling motions of the rotary shafts 72b.

First, at the time of low friction, voltage application from an unillustrated voltage applying portion is stopped to decrease the viscosity of the variable viscosity fluid 72c, thereby decreasing a friction coefficient between the rollers 72a and the rotary shafts 72b to make the rollers 72a rollable. Thus, a friction state between the cared person 101 and the rollers 72a, i.e. the loading/unloading unit 72 becomes a low friction state, wherefore the loading/unloading unit 72 can be smoothly inserted and withdrawn.

On the other hand, at the time of high friction, a voltage is applied from the unillustrated voltage applying portion to increase the viscosity of the variable viscosity fluid 72c, thereby increasing a friction coefficient between the rollers 72a and the rotary shafts 72b to stop the rotation of the rollers 72a. Thus, a friction state between the cared person 101 and the rollers 72a, i.e. the loading/unloading unit 72 becomes a high friction state, wherefore the cared person 101 can be moved while being stably held on the loading/unloading unit 72.

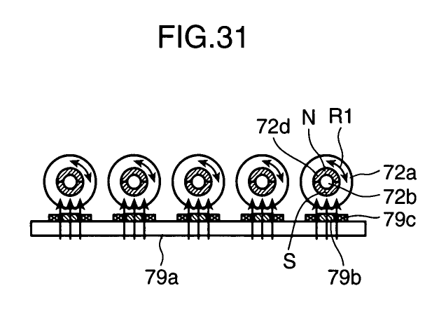

FIG. 31 is a schematic diagram showing states at the times of low friction and high friction of other rollers 72a usable in the loading/unloading unit 72 shown in FIG. 26. Permanent magnets 72d in the form of round tubes are fixed on the inner circumferential surfaces of the rollers 72a, and are supported rotatably in rotating directions R1 on rotary shafts 72 fixed to the loading/unloading unit 72. The permanent magnets 72d are magnetized to have specified polarities. For example, an upper part in FIG. 31 is magnetized to have an N-pole and a lower part is magnetized to have an S-pole. A plurality of iron cores 79b and coils 79c are fixed to a base portion 79a provided in the loading/unloading unit 72, and the respective iron cores 79b and coils 79c are arranged such that the centers thereof coincide with those of the rollers 72a.

First, at the time of low friction, voltage application from an unillustrated voltage applying portion is stopped to stop the generation of magnetic fluxes from the iron cores 79b and the coils 79c to make the rollers 72a rollable. Thus, a friction state between the cared person 101 and the rollers 72a, i.e. the loading/unloading unit 72 becomes a low friction state, wherefore the loading/unloading unit 72 can be smoothly inserted and withdrawn.

On the other hand, at the time of high friction, a voltage is applied from the unillustrated voltage applying portion to cause magnetic fluxes to be generated from the iron cores 79b and the coils 79c, thereby attracting the lower parts of the permanent magnets 72d to stop the rotation of the rollers 72a. Thus, a friction state between the cared person 101 and the rollers 72a, i.e. the loading/unloading unit 72 becomes a high friction state, wherefore the cared person 101 can be moved while being stably held on the loading/unloading unit 72.

By the above constructions, in this embodiment, a friction controlling object such as the slide member 73a is, for example, brought into contact with the rolling surfaces of transport intermediates such as rollers 72a, thereby changing contact pressures and contact areas of the transport intermediates and the friction controlling object to control the operation of the friction controlling object.

When the cared person 101 is transferred from the loading/unloading units 72 to the bed 102 or from the bed 102 to the loading/unloading units 72, the friction between the cared person 101 and the loading/unloading units 72 is minimized by maximally reducing the contact forces or separating the transport intermediates. When the cared person 101 is held on the loading/unloading units 72, the friction between the cared person 101 and the loading/unloading units 72 is maximized by maximally increasing the contact forces. As a result, the loading/unloading units 72 can be smoothly inserted and withdrawn and the cared person 101 can be loaded and moved while being stably placed on the loading/unloading units 72.

Since the loading/unloading units 72 can be made thinner by using the small-diameter rollers 72a, burdens on the cared person 101 at the times of insertion and withdrawal can be reduced. Further, since the loading/unloading units 72 can be made flexible by making the rollers 72a of soft resin or the like, the loading/unloading units 72 can be deformed along the body shape of the cared person 101 to reduce burdens on human bodies at the times of insertion and withdrawal and the cared person 101 can be stably held.

By suitably changing the number and shape of the rollers 72a, the loading/unloading units 72 can be easily made smaller or larger and this transfer apparatus can be used in various applications. By unitizing the loading/unloading units 72, the friction state can be adjusted for each area. If a shear force partially acts between the cared person 101 and the loading/unloading units 72, the influence of the unnecessary shear force can be eliminated by reducing the friction only near the shear-force acting part.

In the above examples are described the friction controlling mechanisms for controlling the friction states using mechanical displacements caused by mechanical operations of bringing the wedges into contact and separating the wedges or moving the plate upward and downward, volumetric changes caused by the expansion and shrinkage of a fluid bag such as an airbag, potential changes caused by attraction, repulsion or adsorption caused by electromagnetism, or electrical or magnetic viscosity changes. However, the friction controlling mechanism may adopt another method such as a powder clutch method using magnetic powder without being particularly limited to these examples provided that the low friction state and the high friction state can be switched. Further, rollable bodies other than the rollers and slidable bodies other than plate members may be used as the transport intermediates, and various friction controlling objects can be used provided that they can change the contact pressures or contact areas by coming into contact with the rolling surfaces, rotary shifts or sliding surfaces of these transport intermediates.

### Seventh Embodiment

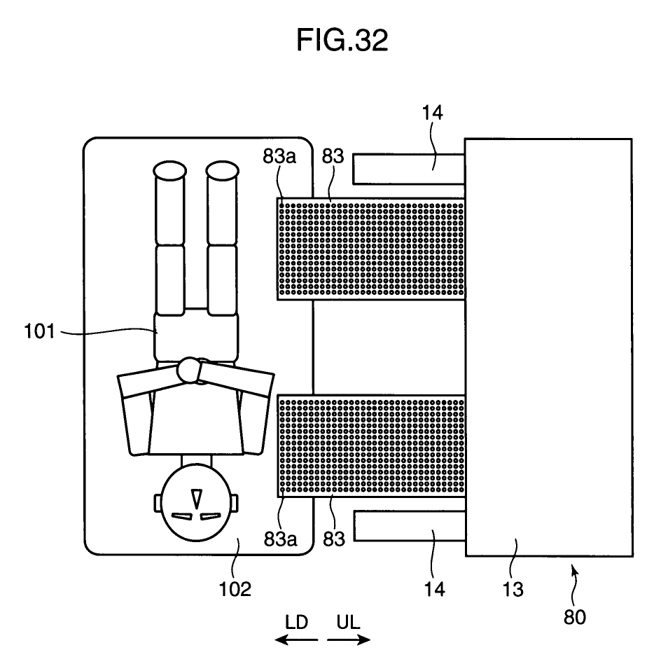

A transfer apparatus according to a seventh embodiment of the present invention uses balls instead of the rollers used in the sixth embodiment. With reference to the drawing, the construction of the transfer apparatus of this embodiment is described below. FIG. 32 is a schematic plan view showing the construction of the transfer apparatus according to the seventh embodiment of the present invention. It should be noted that the same parts as in the first embodiment are identified by the same reference numerals and not described in detail.

As shown in FIG. 32, a transfer apparatus 80 is provided with two loading/unloading units 83 each including a plurality of balls 83a having a spherical shape, wherein the plurality of balls 83a are arranged in a matrix along a load direction LD (or unload direction UL) and a direction normal to this direction. For example, balls having a small diameter of about 1 to 2 mm can be used as the balls 83a. The balls 83a are rotatably supported by the friction controlling mechanism shown in FIGS. 27A to 31 similar to the rollers 72a of the sixth embodiment.

As a result, the balls 83a are made rollable at the time of low friction in this embodiment. Thus, a friction state between the cared person 101 and the balls 83a, i.e. the loading/unloading units 83 becomes a low friction state, wherefore the loading/unloading units 83 can be smoothly inserted and withdrawn. On the other hand, at the time of high friction, the rotation of the balls 83a is stopped. Thus, a friction state between the cared person 101 and the balls 83a, i.e. the loading/unloading units 83 becomes a high friction state, wherefore the cared person 101 can be moved while being stably placed on the loading/unloading units 83.

In this embodiment, the shape of the loading/unloading units 83 can be arbitrarily changed by suitably changing the arranged positions and the like of the small-diameter balls 83a, and the friction state can be adjusted for each area. If a shear force partially acts between the cared person 101 and the loading/unloading units 83, the influence of the unnecessary shear force can be easily eliminated by reducing the friction only near the shear-force acting part.

Although the balls are used as the transport intermediates in this embodiment, other rollable bodies in the form of barrel-shaped or bobbin-shaped cylinders, and another slidable body such as an endless belt, a sheet or a plate member may be used without being particularly limited to this example.

### Eighth Embodiment

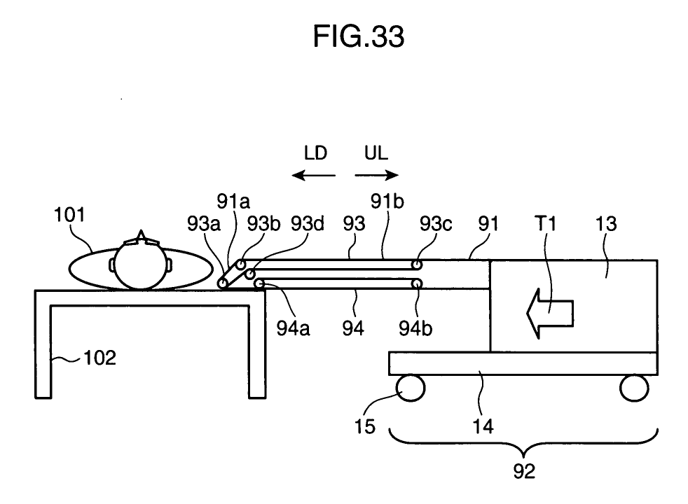

A transfer apparatus according to an eighth embodiment of the present invention uses loading/unloading units having endless belts instead of the loading/unloading units 11 used in the first embodiment, wherein the endless belts are vibrated by the minute forward and reverse feeds thereof. With reference to the drawing, the construction of the transfer apparatus of this embodiment is described below. FIG. 33 is a schematic side view showing the construction of the transfer apparatus according to the eighth embodiment of the present invention. It should be noted that the same parts as in the first embodiment are identified by the same reference numerals and not described in detail.

As shown in FIG. 33, a transfer apparatus 92 is provided with two loading/unloading units 91, in each of which an upper belt 93 and a lower belt 94 are rotatably mounted. The upper belt 93 is made rotatable by being mounted on rollers 93a, 93b and 93c and having a roller 93d arranged on its outer circumferential side, and an oblique surface 91a is formed at an end of the upper belt 93 near a cared person 101. The lower belt 94 is made rotatable by being mounted on rollers 94a, 94b and is arranged below the upper belt 93. The end of each loading/unloading unit 91 near the cared person 101 has a pointed shape, and the loading/unloading unit 91 has a flat trapezoidal shape with a pointed end.

At least one of the rollers 93a to 93d is a drive roller having a driving mechanism such as a drive motor inside, and the other rollers are driven rollers. The upper belt 93 is vibrated by minute amounts of the forward and reverse rotations of the drive roller, whereby the oblique surface 91a and an upper surface 91b as contact areas of the loading/unloading unit 91 vibrate. A driving circuit and the like for rotating the drive roller is built in a lower part of a transfer bed unit 13.

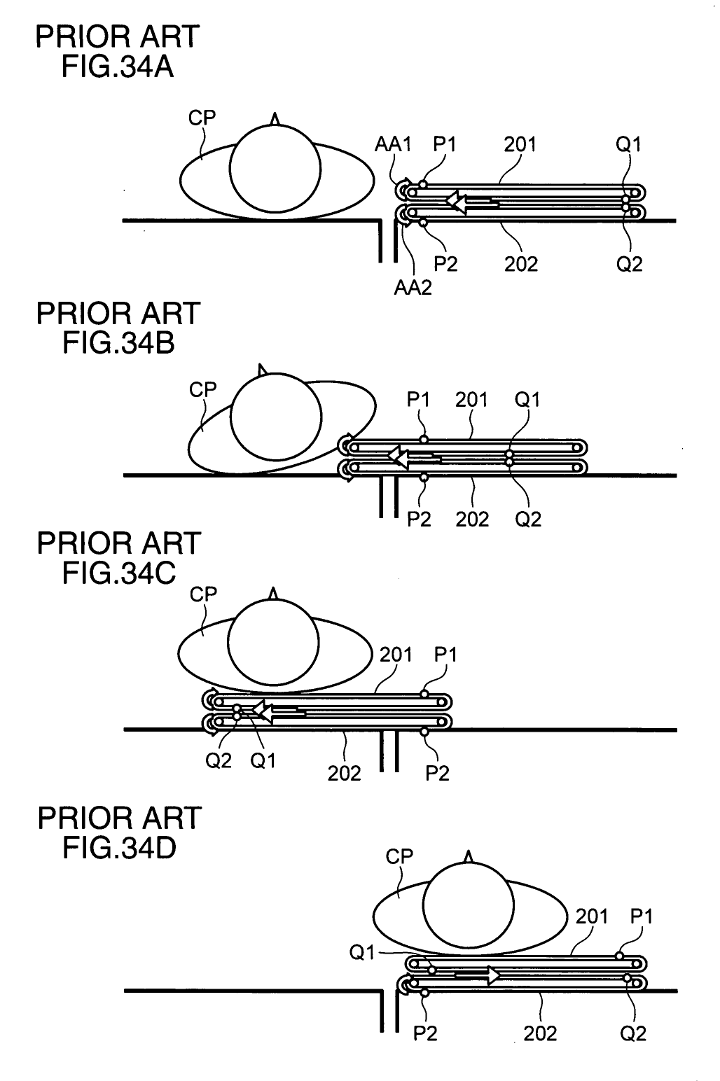

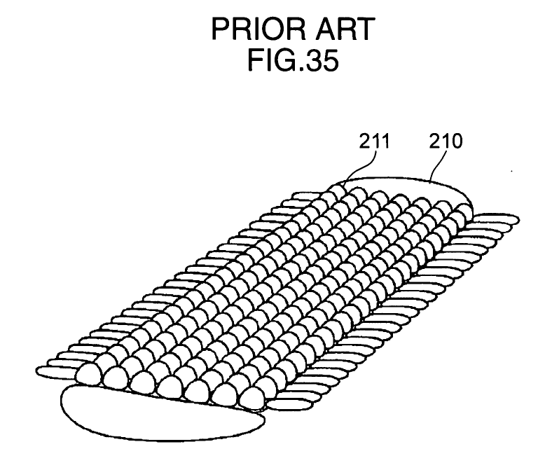

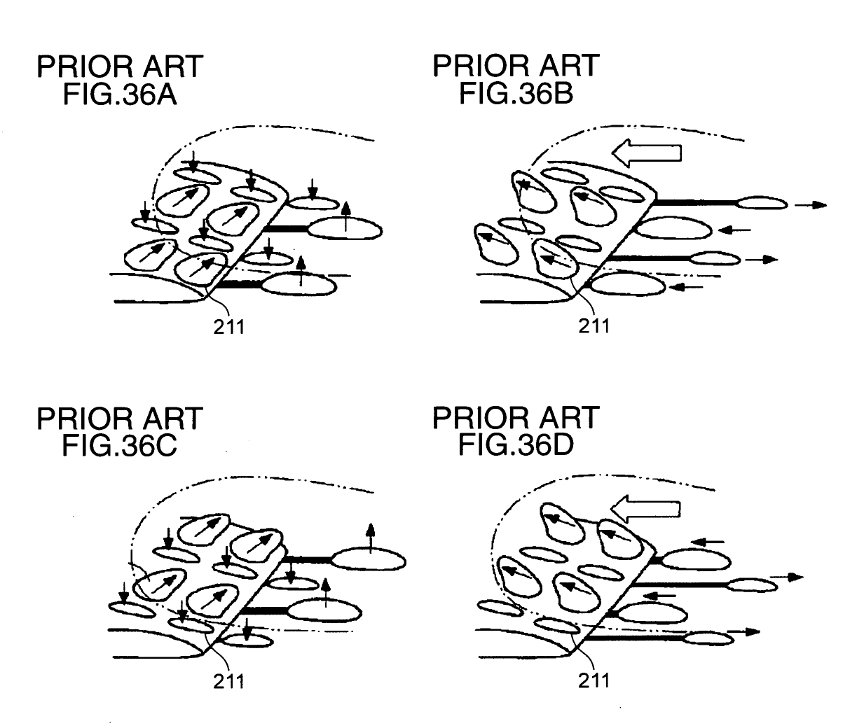

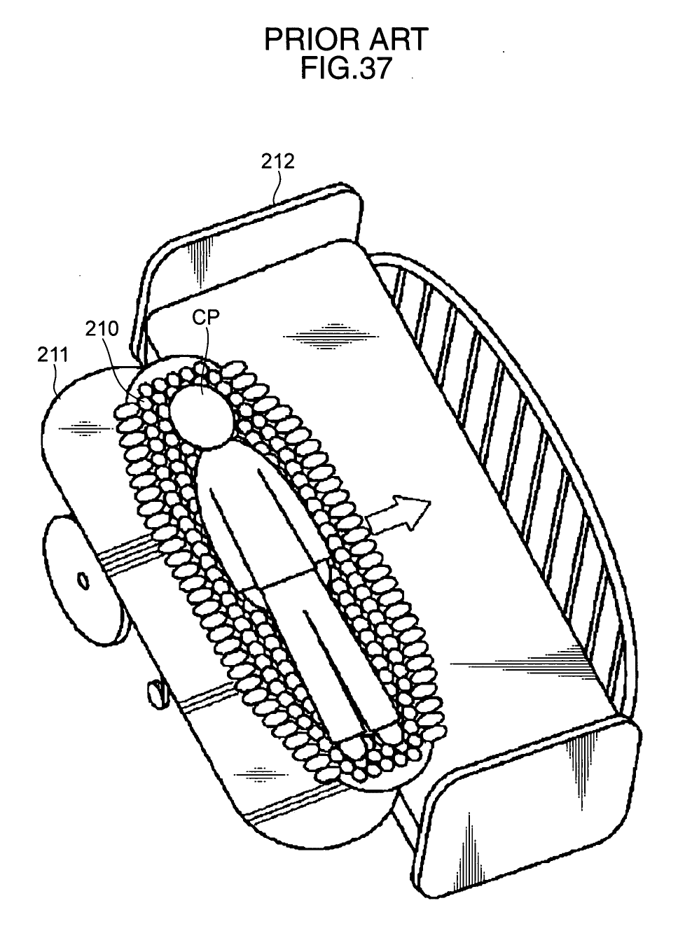

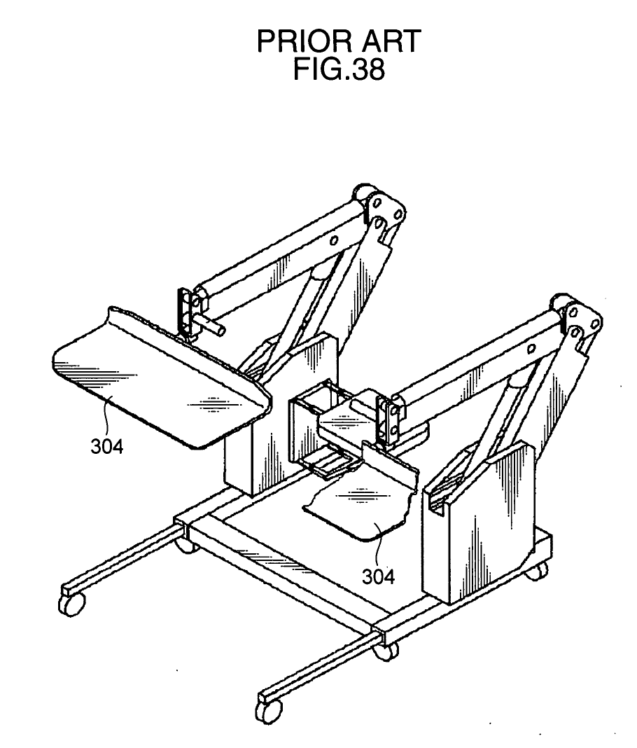

Upon moving the cared person 101, the upper belts 93 are vibrated by the minute amounts of the forward and reverse rotations of the drive rollers, and the upper surfaces 91b as the contact areas of the loading/unloading units 91 vibrate in the load direction LD and the unload direction UL shown while the oblique surfaces 91a vibrate in directions along their principle planes. It should be noted that the operation of the lower belts 94 are as shown in FIGS. 34A to 34D.

As described above, according to this embodiment, the oblique surfaces 91a as the contact areas are vibrated in the directions along their principle planes and the upper surfaces 91b as contact areas are vibrated in the load directions LD and the unload direction UL by driving and vibrating the upper belts 93 of the loading/unloading units 91. Thus, a burden on the cared person 101 can be reduced by setting a dynamic friction state between the cared person 101 and the loading/unloading units 91.

Although only the upper belts 93 are vibrated in this embodiment, various changes can be made without being particularly limited to this example. For example, at least one of the rollers 94a, 94b may be a drive roller having a driving mechanism such as a drive motor inside with the other roller being a driven roller, and the lower belt 94 may be vibrated in the shown load direction LD and unload direction UL by minute amounts of the forward and reverse rotations of the drive roller. In this case, frictional forces can be reduced by setting a dynamic friction state between the loading/unloading units 91 and the bed 102.

Further, the lower belts 94 may be omitted and belts having a flat trapezoidal shape with a pointed end may be vibrated as the upper belts in the case where the lower belts 94 are not vibrated; the upper belts 93 and the lower belts 94 may be vibrated by vibrating the entire loading/unloading units 91; or the upper belts 93 and the lower belts 94 may be directly vibrated using ultrasonic motors or the like.

The present invention can be summarized as follows from the above respective embodiments. Specifically, a loading/unloading unit according to the present invention comprises a base formed with a contact portion having a contact area to be brought into contact with a cared person, wherein a friction state between the contact area and the cared person is variable.

Since the friction state between the contact area and the cared person is variable in this loading/unloading unit, the base can be smoothly inserted and withdrawn by setting a low friction state between the contact area and the cared person upon loading the cared person on the base or unloading the cared person from the base. As a result, the cared person can be loaded on the base or unloaded from the base without providing any large mechanical displacing portion, and the cared person can be safely transferred while preventing an occurrence of the entanglement of the hair and the like of the cared person.

The friction state between the contact area and the cared person is preferably made variable by vibrating the contact area to make at least one of the vibration amplitude or vibration frequency of the contact area variable.

In this case, since the friction state between the contact area and the cared person is made variable by vibrating the contact area to make at least one of the vibration amplitude or vibration frequency of the contact area variable, the cared person can be loaded on the base or unloaded from the base without providing any large mechanical displacing portion by vibrating at least the contact area, and the cared person can be safely transferred while preventing an occurrence of the entanglement of the hair and the like of the cared person.

If it is assumed that a direction of inserting the contact portion under the cared person is a load direction, a direction opposite to the load direction is an unload direction, a direction normal to the load direction at a left side in a horizontal plane is a leftward direction and a direction opposite to the leftward direction is a rightward direction, the contact area is preferably vibrated to have components of at least one pair of vibration directions out of the load and unload directions, gravity and antigravity directions, and the leftward and rightward directions.

In this case, since at least the contact area is vibrated to have components of at least one pair of vibration directions out of the load and unload directions, the gravity and antigravity directions, and the leftward and rightward directions, a frictional force between the contact area of the contact portion and the cared person, the bed on which the cared person is lying on his back and the like can be reduced upon loading the cared person on the base or unloading him from the base. Therefore, the cared person can be easily loaded on the base or unloaded from the base.

If it is assumed that a direction of inserting the contact portion under the cared person is a load direction and a direction opposite to the load direction is an unload direction, at least the contact area is preferably vibrated to have components of the antigravity direction and the unload direction upon loading the cared person on the base.

In this case, since the contact area is vibrated to have components of the antigravity direction and the unload direction upon loading the cared person on the base, a normal force to the contact area increases by the counteraction caused by the inertia of the cared person in response to an upward acceleration of the contact area, thereby increasing a frictional force. Thus, the cared person can be easily loaded on the base.

The vibration of the contact area preferably contains such a rotational movement as to turn a vector in the antigravity direction in the contact area toward the unload direction upon loading the cared person on the base.

In this case, since the vibration of the contact area contains such a rotational movement as to turn the vector in the antigravity direction in the contact area toward the unload direction upon loading the cared person on the base, a displacement of the cared person per amplitude becomes larger, whereby the cared person can be loaded on the base within a shorter period of time.

A vibrating state of the contact area is preferably switched for a loading operation of loading the cared person on the base and an unloading operation of unloading the cared person from the base so that the vibration speed or vibration acceleration of the contact area differs in the load direction and the unload direction.

In this case, since the vibrating state of the contact area is switched for the loading operation and the unloading operation so that the vibration speed or vibration acceleration of the contact area differs in the load direction and the unload direction, both operations can be selectively realized by increasing the frictional force at the time of a movement in the unload direction during the loading operation while increasing the frictional force at the time of a movement in the load direction during the unloading operation.

The vibration speed of the contact area in the unload direction is preferably slower than that in the load direction during the loading operation.

In this case, since the vibration speed of the contact area in the unload direction is slower than that in the load direction during the loading operation, the friction force at the time of the movement in the unload direction during the loading operation can be increased, whereby the cared person can be easily loaded.

An absolute value of the vibration acceleration of the contact area at the time of a switch from the unload direction to the load direction is preferably larger than that of the vibration acceleration of the contact area at the time of a switch from the load direction to the unload direction during the loading operation.

In this case, since the absolute value of the vibration acceleration of the contact area at the time of the switch from the unload direction to the load direction is larger than that at the time of the switch from the load direction to the unload direction during the loading operation, an inertial force at the time of the switch decreases, whereby the slip of the cared person in the load direction during the loading direction can be suppressed.

If it is assumed that a direction of inserting the contact portion under the cared person is a load direction and a direction opposite to the load direction is an unload direction, it is preferable to make the friction coefficient of the contact area larger in the unload direction than in the load direction upon loading the cared person on the base and to make the friction coefficient of the contact area smaller in the unload direction than in the load direction upon unloading the cared person from the base.

In this case, since the friction coefficient of the contact area is made larger in the unload direction than in the load direction upon loading the cared person on the base, it is possible to decrease the frictional force upon moving the contact portion in the load direction while increasing the frictional force upon moving the contact portion in the unload direction, wherefore the cared person can be easily loaded on the base. Further, since the friction coefficient of the contact area is made smaller in the unload direction than in the load direction upon unloading the cared person from the base, it is possible to decrease the frictional force upon moving the contact portion in the unload direction while increasing the frictional force upon moving the contact portion in the load direction, wherefore the cared person can be easily unloaded from the base.

The contact portion preferably selectively switches a direction in which the friction coefficient is larger depending on the operation of loading the cared person on the base or the operation of unloading the cared person from the base.

In this case, since the friction coefficient can be switched suitably for the operation of loading the cared person on the base and the operation of unloading the cared person from the base, both operations can be easily performed.

It is preferable that the contact portion includes a first contact member having a large friction coefficient in a direction suitable for the operation of loading the cared person on the base and a second contact member having a large friction coefficient in a direction suitable for the operation of unloading the cared person from the base; and that the first and second contact members are selectively switched depending on the operation of loading the cared person on the base or the operation of unloading the cared person from the base.

In this case, the first contact member having the large friction coefficient in the direction suitable for the operation of loading the cared person on the base is used for the operation of loading the cared person on the base and the second contact member having the large friction coefficient in the direction suitable for the operation of unloading the cared person from the base is used for the operation of unloading the cared person from the base, wherefore the contact member can be switched to the one suitable for the targeted operation and both operations can be easily performed.

A plurality of fibrous elastic bodies aligned in a specified direction parallel to a plane including the gravity direction, the load direction and the unload direction and inclined with respect to the gravity direction are preferably provided on the outer surface of the contact area.

In this case, since the plurality of fibrous elastic bodies are aligned in the specified direction parallel to the plane including the gravity direction, the load direction and the unload direction and inclined with respect to the gravity direction, it is possible to make the friction coefficient in the load direction larger than that in the unload direction and to make the friction coefficient in the unload direction larger than that in the load direction.

The contact portion may include a serrated member having a serrated shape whose cross-section parallel to the plane including the gravity direction, the load direction and the unload direction is asymmetric with respect to the gravity direction.

In this case, since the contact portion includes the serrated member having the serrated shape whose cross-section parallel to the plane including the gravity direction, the load direction and the unload direction is asymmetric with respect to the gravity direction, it is possible to make the friction coefficient in the load direction larger than that in the unload direction and to make the friction coefficient in the unload direction larger than that in the load direction.

It is preferable that the contact portion includes a belt; that the contact area is formed on the upper surface of the belt; that the contact area is mainly movable in the load direction and the unload direction and mainly vibrated in the load direction and the unload direction by the belt being driven.

In this case, since the contact area is mainly vibrated in the load direction and the unload direction by the belt being driven, the frictional force between the contact area of the contact portion and the cared person, the bed on which the cared person is lying on his back and the like can be reduced upon loading the cared person on the base or unloading him from the base. Therefore, the cared person can be easily loaded on the base or unloaded from the base.

It is preferable to apply an antistatic finish to at least the contact area. In this case, the usability of the loading/unloading unit can be improved since electric charges accumulated in the contact area can be grounded even if the contact area is frequently abraded by the cared person.

A transfer apparatus according to the present invention comprises at least first and second loading/unloading units, wherein the first and second loading/unloading units are those according to any one of the above loading/unloading units.

In this transfer apparatus, a friction state between the contact areas and the cared person can be made variable since the loading/unloading units according to any one of the above are used as the first and second loading/unloading units. As a result, the cared person can be loaded on the base or unloaded from the base without providing any large mechanical displacing portion, and the cared person can be safely transferred while preventing an occurrence of the entanglement of the hair and the like of the cared person. Further, since at least two loading/unloading units are provided, the operations of the two loading/unloading units can be individually adjusted according to the posture of the cared person, whereby the inclination of the cared person relative to the transfer apparatus can be suppressed.

It is preferable to further comprise a system controller that can individually adjust vibration characteristics of the contact areas of the first and second loading/unloading units.

In this case, since the vibration characteristics of the contact areas of the first and second loading/unloading units can be individually adjusted, the inclination of the cared person relative to the transfer apparatus can be suppressed by correcting the inclination of the cared person upon loading the cared person on the base or unloading him from the base.

The system controller preferably adjusts the vibration characteristics of the contact areas of the first and second loading/unloading units in accordance with inclination information corresponding to a relative angle of a direction of the backbone of the cared person lying on his back to the load direction or the unload direction if a direction of inserting the contact portions under the cared person is a load direction and a direction opposite to the load direction is an unload direction.

In this case, since the vibration characteristics of the contact areas of the first and second loading/unloading units are adjusted in accordance with the inclination information corresponding to the relative angle of the direction of the backbone of the cared person lying on his back to the load direction or the unload direction, frictional forces acting on the cared person in the first and second loading/unloading units can be individually adjusted, whereby the inclination of the cared person relative to the transfer apparatus can be precisely corrected.

It is preferable that first and second marker arranged in parallel with the direction of the backbone of the cared person and first and second distance sensors for detecting distances to the first and second markers are further provided; and that the system controller calculates the inclination information based on the respective distances from the first and second distance sensors to the first and second markers.

In this case, since the distances to the first and second markers arranged in parallel with the direction of the backbone of the cared person are detected using the first and second distance sensors and the inclination information is calculated based on the respective distances, the inclination information corresponding to the relative angle of the direction of the backbone of the cared person lying on his back to the load direction or the unload direction can be precisely calculated.

The system controller preferably adjusts the vibration amplitudes or vibration frequencies of the contact areas of the first and second loading/unloading units.

In this case, since the vibration amplitudes or vibration frequencies of the contact areas of the first and second loading/unloading units are adjusted, the vibration characteristics of the contact areas of the first and second loading/unloading units can be minutely controlled and the inclination of the cared person upon loading the cared person on the base or unloading him from the base can be more precisely corrected.

Since the loading/unloading unit according to the present invention is free from an occurrence of the entanglement or the like upon transferring the cared person, the transfer operation can be safely performed and is useful as the one used in a transfer apparatus.

This application is based on Japanese patent application serial No. 2006-176826, filed in Japan Patent Office on Jun. 27, 2006, the contents of which are hereby incorporated by reference.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. A loading/unloading unit, comprising a base formed with a contact portion having a contact area to be brought into contact with a cared person, wherein a friction state between the contact area and the cared person is variable.

2. A loading/unloading unit according to claim 1, wherein the friction state between the contact area and the cared person is made variable by vibrating the contact area to make at least one of the vibration amplitude or vibration frequency of the contact area variable.

3. A loading/unloading unit according to claim 2, wherein, if it is assumed that a direction of inserting the contact portion under the cared person is a load direction, a direction opposite to the load direction is an unload direction, a direction normal to the load direction at a left side in a horizontal plane is a leftward direction and a direction opposite to the leftward direction is a rightward direction, the contact area is vibrated to have components of at least one pair of vibration directions out of the load and unload directions, gravity and antigravity directions, and the leftward and rightward directions.

4. A loading/unloading unit according to claim 2, wherein, if it is assumed that a direction of inserting the contact portion under the cared person is a load direction and a direction opposite to the load direction is an unload direction, at least the contact area is vibrated to have components of the antigravity direction and the unload direction upon loading the cared person on the base.

5. A loading/unloading unit according to claim 4, wherein the vibration of the contact area contains such a rotational movement as to turn a vector in the antigravity direction in the contact area toward the unload direction upon loading the cared person on the base.

6. A loading/unloading unit according to claim 3, wherein a vibrating state of the contact area is switched for a loading operation of loading the cared person on the base and an unloading operation of unloading the cared person from the base so that the vibration speed or vibration acceleration of the contact area differs in the load direction and in the unload direction.

7. A loading/unloading unit according to claim 6, wherein the vibration speed of the contact area in the unload direction is slower than that in the load direction during the loading operation.

8. A loading/unloading unit according to claim 6, wherein an absolute value of the vibration acceleration of the contact area at the time of a switch from the unload direction to the load direction is larger than that of the vibration acceleration of the contact area at the time of a switch from the load direction to the unload direction during the loading operation.

9. A loading/unloading unit according to claim 2, wherein, if a direction of inserting the contact portion under the cared person is a load direction and a direction opposite to the load direction is an unload direction,
the friction coefficient of the contact area is made larger in the unload direction than in the load direction upon loading the cared person on the base while being made smaller in the unload direction than in the load direction upon unloading the cared person from the base.

10. A loading/unloading unit according to claim 9, wherein the contact portion selectively switches a direction in which the friction coefficient is larger depending on the operation of loading the cared person on the base or the operation of unloading the cared person from the base.

11. A loading/unloading unit according to claim 9, wherein:
the contact portion includes a first contact member having a large friction coefficient in a direction suitable for the operation of loading the cared person on the base and a second contact member having a large friction coefficient in a direction suitable for the operation of unloading the cared person from the base; and
the first and second contact members are selectively switched depending on the operation of loading the cared person on the base or the operation of unloading the cared person from the base.

12. A loading/unloading unit according to claim 9, wherein a plurality of fibrous elastic bodies aligned in a specified direction parallel to a plane including the gravity direction, the load direction and the unload direction and inclined with respect to the gravity direction are provided on the outer surface of the contact area.

13. A loading/unloading unit according to claim 9, wherein the contact portion includes a serrated member having a serrated shape whose cross-section parallel to the plane including the gravity direction, the load direction and the unload direction is asymmetric with respect to the gravity direction.

14. A loading/unloading unit according to claim 3, wherein:
the contact portion includes a belt;
the contact area is formed on the upper surface of the belt; and
the contact area is mainly movable in the load direction and the unload direction and mainly vibrated in the load direction and the unload direction by the belt being driven.

15. A loading/unloading unit according to claim 1, wherein an antistatic finish is applied to at least the contact area.

16. A transfer apparatus, comprising at least first and second loading/unloading units, wherein the first and second loading/unloading units are loading/unloading units according to claim 1.

17. A transfer apparatus according to claim 16, further comprising a system controller that can individually adjust vibration characteristics of the contact areas of the first and second loading/unloading units.

18. A transfer apparatus according to claim 17, wherein the system controller adjusts the vibration characteristics of the contact areas of the first and second loading/unloading units in accordance with inclination information corresponding to a relative angle of a direction of the backbone of the cared person lying on his back to the load direction or the unload direction if a direction of inserting the contact portions under the cared person is a load direction and a direction opposite to the load direction is an unload direction.

19. A transfer apparatus according to claim 18, further comprising first and second marker arranged in parallel with the direction of the backbone of the cared person and first and second distance sensors for detecting distances to the first and second markers, wherein the system controller calculates the inclination information based on the respective distances from the first and second distance sensors to the first and second markers.

20. A transfer apparatus according to claim 17, wherein the system controller adjusts the vibration amplitudes or vibration frequencies of the contact areas of the first and second loading/unloading units.
